(19) United States
(12) Patent Application Publication
(10) Pub. No.: US 2026/0009729 A1
(43) Pub. Date: Jan. 8, 2026

(54) SYSTEMS AND METHODS FOR MEASURING FLUORESCENCE

(71) Applicant: TRIPLET IMAGING, INC., San Francisco, CA (US)

(72) Inventors: Jaime Wong-Campos, Cambridge, MA (US); Mackenzie Dion, San Francisco, CA (US)

(21) Appl. No.: 19/262,819

(22) Filed: Jul. 8, 2025

Related U.S. Application Data
(60) Provisional application No. 63/668,493, filed on Jul. 8, 2024.
(60) Provisional application No. 63/722,380, filed on Nov. 19, 2024.
(60) Provisional application No. 63/783,467, filed on Apr. 4, 2025.

(51) Int. Cl. G01N 21/64; G01N 21/25; G01N 21/35

(52) U.S. Cl. CPC G01N 21/64; G01N 21/255; G01N 21/35; G01N 2021/6419; G01N 2021/6471; G01N 2021/6478

(57) ABSTRACT

Systems for irradiating a sample are disclosed. The system includes a first light source configured to produce a visible light beam having a visible wavelength range to produce a population of triplet states in the sample. The system further includes an optical assembly to direct light beam. The system additionally includes an objective that directs the light beam onto the sample. Methods of irradiating a sample are also disclosed.

### CROSS-REFERENCE TO RELATED APPLICATIONS

This application claims priority under 35 U.S.C. § 119 (e) to U.S. Provisional Patent Application Ser. No. 63/668,493, titled “SYSTEMS AND METHODS FOR MEASURING FLUORESCENCE,” filed Jul. 8, 2024, U.S. Provisional Patent Application Ser. No. 63/722,380, titled “SYSTEMS AND METHODS FOR MEASURING FLUORESCENCE,” filed Nov. 19, 2024, and U.S. Provisional Patent Application Ser. No. 63/783,467, titled “SYSTEMS AND METHODS FOR MEASURING FLUORESCENCE,” filed Apr. 4, 2025, the entire contents of each are incorporated herein by reference for all purposes.

### FIELD OF TECHNOLOGY

Aspects and embodiments disclosed herein relate to systems and methods for generating and measuring fluorescence using visible and/or infrared (IR) wavelengths.

### SUMMARY

In accordance with an aspect, there is provided a system for irradiating a sample. The system may include a one or more light sources configured to produce a light beam, e.g., one or more light beams, having a wavelength range to produce a population of excited singlet states derived from relaxation of a population of higher order triplet states in the sample. The system may include an optical assembly constructed and arranged to direct the light beam, e.g., one or more light beams. The system further may include a first objective constructed and arranged to irradiate the sample with the light beam, e.g., one or more light beams.

In some embodiments, the one or more light sources may be a visible light source. When the one or more light sources is a visible light source, the visible wavelength range may be between about 400 nm to about 700 nm.

In some embodiments, the one or more light sources may be an infrared (IR) light source. When the one or more light sources is an IR light source, the IR wavelength range may be between about 750 nm to about 1000 nm.

In some embodiments, the one or more light sources may be a pulsed light source or a continuous wave light source. In some embodiments, the one or more light sources used in any system disclosed herein can be a CW light source that includes an external modulation system, e.g., EOM or AOM. The external modulation system can be arranged to a sequence of modulated light pulses from the CW light source.

For example, the one or more light sources, whether pulsed or continuous wave, may be a fixed wavelength light source. Alternatively, the one or more light sources, whether pulsed or continuous wave, may be a supercontinuum light source. When the one or more light sources is a supercontinuum light source, the wavelength range from the supercontinuum light source may be set using a filter. The filter for the supercontinuum light source may be selected from the group consisting of an acousto-optic tunable filter and a linear variable filter.

In some embodiments, a signal representative of fluorescence in the sample may be collected by the first objective.

In further embodiments, the system may include a second objective constructed and arranged to collect a signal representative of fluorescence in the sample.

In further embodiments, the system may include a detector constructed and arranged to receive the signal representative of fluorescence in the sample and to provide an output representative thereof.

In accordance with an aspect, there is provided a method of irradiating a sample. The method may include generating from one or more light sources one or more light beams having a wavelength range chosen to produce a population of excited singlet states derived from relaxation of a population of higher order triplet states in the sample. The method may include applying the one or more light beams to the sample using an objective to produce a population of triplet states and a population of excited singlet states in the sample.

In further embodiments, the method may include detecting fluorescence from the sample. Detecting fluorescence from the sample may include receiving fluorescent emissions from relaxation of the population of excited singlet states in the sample at a photosensitive detector.

In some embodiments, the one or more light sources may be a visible light source. When the one or more light sources is a visible light source, the visible wavelength range may be between about 400 nm to about 700 nm.

In some embodiments, the one or more light sources may be an infrared (IR) light source. When the one or more light sources is an IR light source, the IR wavelength range may be between about 750 nm to about 1000 nm.

In some embodiments, the one or more light sources may be a pulsed light source or a continuous wave light source. In some embodiments, the one or more light sources used in any system disclosed herein can be a CW light source that includes an external modulation system, e.g., EOM or AOM. The external modulation system can be arranged to a sequence of modulated light pulses from the CW light source. For example, the one or more light sources, whether pulsed or continuous wave, may be a fixed wavelength light source. Alternatively, the one or more light sources, whether pulsed or continuous wave, may be a supercontinuum light source. When the one or more light sources is a supercontinuum light source, the wavelength range from the supercontinuum light source may be set using a filter. The filter for the supercontinuum light source may be selected from the group consisting of an acousto-optic tunable filter and a linear variable filter.

In accordance with an aspect, there is provided a system for irradiating a sample. The system may include a one or more light sources configured to produce a light beam, e.g., one or more light beams, having a wavelength range to produce a population of a first triplet state in the sample via excitation of a ground state in the sample and a population of higher order triplet states in the sample via excitation of a first triplet state in the sample and a population of excited singlet states derived from relaxation of a population of higher order triplet states in the sample. The system may include an optical assembly constructed and arranged direct the light beam, e.g., one or more light beams. The system further may include a first objective constructed and arranged to irradiate the sample with the light beam, e.g., one or more light beams.

In accordance with an aspect, there is provided a system for irradiating a sample. The system may include a light source apparatus configured to produce a first pulse of supercontinuum light. The system may include a first beamsplitter disposed in a path of the first pulse of supercontinuum light and configured to split the first pulse of supercontinuum light into a first beam and a second beam. The system may include a first filter disposed in a path of the first beam of supercontinuum light and configured to produce a first infrared (IR) light beam having a first IR wavelength range. The first IR light beam may have the first wavelength range set to produce a population of triplet states in the sample. The system further may include a second filter disposed in a path of the second beam of supercontinuum light and configured to produce a second IR light beam having a second IR wavelength range. The second IR wavelength range may be different than the first IR wavelength range. The second IR light beam may be used to produce a population of excited singlet states in the sample. The system further may include an optical assembly disposed to combine the first IR light beam and second IR light beam and configured to create a combined IR beam that irradiates the sample. The system may include an objective disposed to direct the combined IR beam onto the sample. The system additionally may include an IR detector configured to receive a signal representative of fluorescence in the sample and to provide an output representative thereof.

In some embodiments, the first filter may be an acousto-optic tunable filter or a linear variable filter. The first filter, e.g., an acousto-optic tunable filter or a linear variable filter, may be used to produce a first IR wavelength range between about 630 nm to about 800 nm.

In some embodiments, the second filter may be an acousto-optic tunable filter or a linear variable filter. The second filter, e.g., an acousto-optic tunable filter or a linear variable filter, may be used to produce a second IR wavelength range between about 800 nm to about 1000 nm.

In some embodiments, one or both of the first IR light beam and second IR light beam may have azimuthal polarization. For example, the first IR light beam may have azimuthal polarization and the second IR light beam may have a different polarization. In other embodiments, the second IR light beam may have azimuthal polarization and the first IR light beam may have a different polarization.

In particular embodiments, the first IR light beam and second IR light beam may have azimuthal polarization.

In some embodiments, the population of triplet states in the sample may be produced by exciting magnetic dipole transitions in the sample using the first IR light beam.

In some embodiments, the population of excited singlet states in the sample may be produced by populating excited triplet states from the population of triplet states. The population of excited triplet states in the sample can relax, e.g., through Reverse Intersystem Crossing (RISC), to form the population of excited singlet states in the sample.

In further embodiments, the system may include a second beamsplitter disposed in the path of the first pulse of supercontinuum light and configured to produce a third beam of supercontinuum light. The third beam of supercontinuum light may interact with a third filter disposed in its path and configured to pass a visible light beam. The visible light beam may be used to irradiate the sample and produce a population of excited singlet states that fluoresce upon relaxation back to the ground state of the sample.

In further embodiments, the system may include a visible light detector configured to receive a signal representative of fluorescence in the sample and provide an output representative thereof.

In accordance with an aspect, there is provided a method of irradiating a sample. The method may include generating a first IR light beam having a first IR wavelength range and a first polarization. The method may include generating a second IR light beam having a second IR wavelength range and a second polarization. The second IR wavelength range may be different than the first IR wavelength range. The method further may include combining the first IR light beam and the second IR light beam to form a combined IR light beam. The method may include applying the combined IR light beam to a sample to produce a population of triplet states and a population of excited singlet states in the sample.

In some embodiments, the method may include detecting fluorescence from the sample. For example, detecting fluorescence from the sample may include receiving fluorescence emissions from relaxation of the population of excited singlet states, e.g., relaxation to the ground state, in the sample at a photosensitive detector.

In some embodiments, the first IR wavelength range is between about 630 nm to about 800 nm. In some embodiments, the second IR wavelength range may be between about 800 nm to about 1000 nm.

In some embodiments, the first polarization and the second polarization are identical. In other embodiments, the first polarization and the second polarization are different. In some embodiments, one or both of the first polarization and the second polarization may be azimuthal. For example, the first polarization may be azimuthal and the second polarization may be different. In other embodiments, the second polarization may be azimuthal and the first polarization may be different.

In further embodiments, the method may include producing the population of triplet states by exciting magnetic dipole transitions in the sample using the first IR light beam.

In further embodiments, the method may include producing the population of excited singlet states in the sample by populating excited triplet states from the population of triplet states. The population of excited triplet states in the sample can relax, e.g., through RISC, to form the population of excited singlet states in the sample.

In accordance with an aspect, there is provided a system for irradiating a sample. The system may include a light source apparatus configured to produce a first pulse of supercontinuum light. The system may include a first beamsplitter disposed in a path of the first pulse of supercontinuum light and configured to split the first pulse of supercontinuum light into a first beam and a second beam. The system further may include a first filter disposed in a path of the first beam of supercontinuum light and configured to produce a first infrared (IR) light beam having a first IR wavelength range. The system may include a second filter disposed in a path of the second beam of supercontinuum light and configured to produce a second IR light beam having a second IR wavelength range different than the first IR wavelength range. The system may include an optical assembly disposed to combine the first IR light beam and second IR light beam to create a combined IR beam that can irradiate the sample. The system additionally may include an objective disposed to direct the combined IR beam onto the sample.

In some embodiments, the sample may include fluorescent molecules. In some embodiments, the sample may include molecules that are IR active, e.g., no fluorescence by IR photon absorption. For example, the sample may include polymerizable resins and photoresists that can polymerize or degrade upon exposure to IR photons.

In accordance with an aspect, there is provided a system for irradiating a sample. The system may include a first light source configured to produce a visible light beam having a visible wavelength range to produce a first population of triplet states in the sample. The system may include a second light source configured to produce an IR light beam having an IR wavelength range to produce a population of excited singlet states in the sample. The system further may include an optical assembly disposed to combine the visible light beam and IR light beam to create a combined beam that can irradiate the sample. The system additionally may include an objective disposed to direct the combined beam onto the sample.

In some embodiments, the system additionally may include a detector configured to receive a signal representative of fluorescence in the sample and to provide an output representative thereof.

In some embodiments, the visible wavelength range between about 400 nm to about 700 nm.

In some embodiments, the IR wavelength range between about 750 nm to about 1000 nm.

In some embodiments, one or both of the visible light beam and IR light beam may have azimuthal polarization. For example, the first visible beam may have azimuthal polarization and the IR light beam may have a different polarization. In other embodiments, the IR light beam may have azimuthal polarization and the visible light beam may have a different polarization.

In particular embodiments, the visible light beam and the IR light beam may have azimuthal polarization.

In some embodiments, the population of triplet states in the sample may be produced by using the visible light beam.

In some embodiments, the population of excited singlet states in the sample may be produced by populating excited triplet states from the population of triplet states. The population of excited triplet states in the sample can relax, e.g., through Reverse Intersystem Crossing (RISC), to form the population of excited singlet states in the sample.

In further embodiments, the system may include a third light source configured to produce a second visible light beam. The second visible light beam may be used to irradiate the sample and produce a population of excited singlet states that fluoresce upon relaxation back to the ground state of the sample.

In further embodiments, the system may include a visible light detector configured to receive a signal representative of fluorescence in the sample and provide an output representative thereof.

In some embodiments, one or both of the first light source apparatus or the second light source apparatus may include a supercontinuum light source apparatus. In this configuration, at least one filter may be used to produce one or both of the first IR light beam and second IR light beam from the supercontinuum light source apparatus. In certain embodiments, the at least one filter may be an acousto-optic tunable filter or a linear variable filter.

In accordance with an aspect, there is provided a method of irradiating a sample. The method may include generating a visible light beam having a visible wavelength range and a first polarization. The method may include generating an IR light beam having an IR wavelength range and a second polarization. The method further may include combining the visible light beam and IR light beam to form a combined light beam. The method additionally may include applying the combined light beam to the sample to produce a population of triplet states and a population of excited singlet states in the sample.

In some embodiments, the method may include detecting fluorescence from the sample. For example, detecting fluorescence from the sample may include receiving fluorescence emissions from relaxation of the population of excited singlet states, e.g., relaxation to the ground state, in the sample at a photosensitive detector.

In some embodiments, the visible wavelength range is between about 400 nm to about 700 nm. In some embodiments, the IR wavelength range may be between about 750 nm to about 1000 nm.

In some embodiments, the first polarization and the second polarization are identical. In other embodiments, the first polarization and the second polarization are different. In some embodiments, one or both of the first polarization and the second polarization may be azimuthal. For example, the first polarization may be azimuthal and the second polarization may be different. In other embodiments, the second polarization may be azimuthal and the first polarization may be different.

In further embodiments, the method may include producing the population of triplet states by irradiating the sample using the visible light beam.

In further embodiments, the method may include producing the population of excited singlet states in the sample by populating excited triplet states from the population of triplet states. The population of excited triplet states in the sample can relax, e.g., through RISC, to form the population of excited singlet states in the sample.

In some embodiments, 25. excitation with the IR light beam reduces photobleaching in the sample.

In accordance with an aspect, there is provided a system for irradiating a sample. The system may include a light source apparatus configured to produce a first pulse of supercontinuum light. The system may include a first beamsplitter disposed in a path of the first pulse of supercontinuum light and configured to split the first pulse of supercontinuum light into a first beam and a second beam. The system may include a first filter disposed in a path of the first beam of supercontinuum light and configured to produce a visible light beam having a visible wavelength range to produce a population of triplet states in the fluorescent molecules. The system further may include a second filter disposed in a path of the second beam of supercontinuum light and configured to produce an IR light beam having an IR wavelength range set to produce a population of excited singlet states in the fluorescent molecules. The system may include an optical assembly disposed to combine the visible light beam and IR light beam to create a combined beam that can irradiate a sample comprising the fluorescent molecules. The system further may include an objective disposed to direct the combined IR beam onto the sample. The system additionally may include a detector configured to receive a signal representative of fluorescence in the fluorescent molecules and to provide an output representative thereof.

In some embodiments, the sample may include fluorescent molecules. In some embodiments, the sample may include molecules that are IR active, e.g., no fluorescence by IR photon absorption. For example, the sample may include polymerizable resins and photoresists that can polymerize or degrade upon exposure to IR photons. In another non-limiting embodiment, the sample may include opsins where the absorption of IR photons can trigger a conformational change and activate the signaling response of the G-protein in the opsin.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments and are incorporated in and constitute a part of this specification but are not intended as a definition of the limits of the invention. In the figures, each identical or nearly identical component that is illustrated in various figures is represented by a like numeral. For purposes of clarity, not every component may be labeled in every figure. In the drawings:

FIG. 1 illustrates a system for producing and measuring fluorescence in a sample, according to this disclosure; and

FIG. 2 illustrates a flow diagram of an example of a method of producing and measuring fluorescence in a sample, according to this disclosure.

FIG. 3 illustrates an embodiment of a system for producing and measuring fluorescence in a sample, according to this disclosure;

FIG. 4 illustrates another embodiment of a system for producing and measuring fluorescence in a sample, according to this disclosure;

FIG. 5 illustrates a flow diagram of an example of a method of producing and measuring fluorescence in a sample, according to this disclosure;

FIG. 6 illustrates the emission spectrum of an iodine-containing dye embedded in a rigid gel matrix;

FIG. 7 illustrates a spectrum of 630 nm and 900 nm light;

FIG. 8 illustrates the fluorescence lifetimes of an iodine-containing dye at three different excitation wavelengths. Top trace is excitation at 470 nm, center trace is excitation at 630 nm, and bottom trace is excitation at 900 nm;

FIG. 9 illustrates the fluorescence lifetimes of an iodine-containing dye using co-illumination with different wavelengths. Top trace is co-illumination at 470 nm+630 nm, center trace is excitation at 470 nm+900 nm, and bottom trace is excitation at 360 nm+900 nm;

FIG. 10 illustrates the phosphorescence spectra of an iodine-containing dye at different excitation wavelengths;

FIGS. 11A-11B illustrate the enhancement of fluorescence of an iodine-containing dye under different co-illumination wavelengths;

FIG. 12 illustrates fluorescence spectra of a fluorescent protein at different excitation wavelengths;

FIG. 13 illustrates the fluorescence lifetimes of a fluorescent protein at three different excitation wavelengths. Top trace is excitation at 470 nm, center trace is excitation at 630 nm, and bottom trace is excitation at 900 nm;

FIG. 14 illustrates fluorescence counts observed during a power scan at an excitation wavelength of 470 nm;

FIG. 15 fluorescence counts observed during power scans at excitation wavelengths of 630 nm and 900 nm;

FIG. 16 illustrates the photobleaching rate of an fluorescent protein under different excitation conditions;

FIG. 17 illustrates the emission spectrum of a fluorescent protein upon excitation with 638 nm continuous wave light;

FIGS. 18A-18G illustrate the fluorescence characteristics for ErB in 10% PVA; and

FIG. 19A-19F illustrate the phosphorescence characteristics for ErB in 10% PVA.

### DETAILED DESCRIPTION

Aspects and embodiments are directed to systems and methods for the generation and measurement of fluorescence in suitable molecules using one or both of visible and infrared excitation. The generation and measurement of fluorescence using visible and infrared excitation has utility for imaging and stimulation in the life sciences in applications such as microscopy, spectroscopy, and optogenetics without the expensive overhead costs of traditional laser microscopy systems.

Fluorescence occurs from the excitation of the electric field of fluorophores, resulting in the relaxation from a higher energy excited singlet state to the lower energy singlet ground state, e.g., no change in electron spin multiplicity, by the emission of a photon. In phosphorescence, the electron in the fluorophore which absorbed the incident photon undergoes a radiationless process known as intersystem crossing (ISC) into an energy state of different, and usually higher spin multiplicity known as the triplet state. The transitions from the triplet state are kinetically disfavored, resulting in lingering emissions that persist on the order of milliseconds. While the transition from the ground singlet state to the triplet state is “forbidden,” e.g., there is no allowed way of populating the triplet state T₁ from the ground singlet state S₀ by perturbations of the electric field of the fluorophores, this transition is allowed by excitation of higher order magnetic dipole transitions in the fluorophores.

Multiphoton excitation has revolutionized microscopy, materials processing, and spectroscopy through precise three-dimensional control at microscopic scales. The process relies on the simultaneous absorption of multiple photons via virtual intermediate states, requiring high peak powers from femtosecond lasers and point scanning systems, limiting throughput and accessibility. Reducing these power requirements while maintaining nonlinear excitation advantages would enable new approaches to study dynamic processes across large volumes and complex samples.

Magnetic dipole transitions are orders of magnitude weaker than their electric dipole counterparts and thus have generally not been studied as extensively. Among polarized beams, azimuthally polarized beams have a unique magnetic field feature, i.e., the magnetic field oscillating at optical frequencies, of a strong longitudinal magnetic field where the electric field is null, i.e., the electric field is purely transverse to the beam axis. Without wishing to be bound by any particular theory, the magnetic field at optical frequencies is oscillating in the terahertz (THz) frequency range, exceeding that of the magnetic field from a typical solid state magnet or electromagnet. The strong magnetic field along the beam axis at optical frequencies with THz oscillations can provide access to the magnetic dipoles of fluorophores to investigate the fluorescent response upon excitation with an azimuthally polarized beam.

Excited triplet states are believed to be the starting point for many possible photochemical reactions leading to phenomena such as blinking or bleaching. Although the mechanisms of blinking and bleaching are not fully understood, it is often assumed that bleaching involves the excited triplet excited state of the fluorophore and its interactions with the surrounding medium, such as molecular oxygen in air. It is an object of the present disclosure to take advantage of direct access to the first excited triplet state and accessible higher order triplet states Tₙ, n>1 using polarized beams to generate and measure fluorescence in fluorophores and to understand the mechanisms that contribute to photobleaching and phototoxicity. In some embodiments, the accessed higher order triplet states may be a single higher order triplet state Tₙ, n>1. In other embodiments, the accessed higher order triplet states may be a plurality of higher order triplet states Tₙ, n>1. The decay of any higher order triplet states may be into one more excited singlet states Sₙ, n>1.

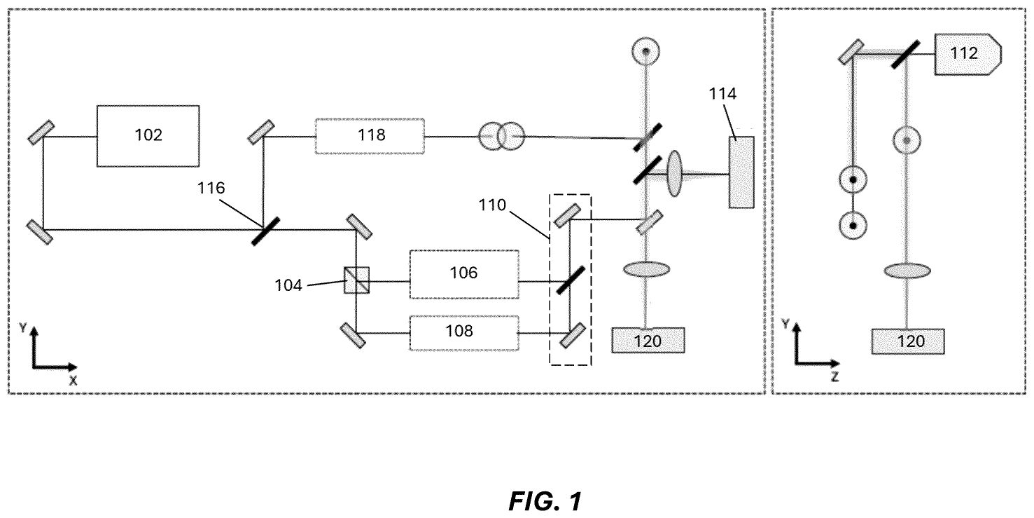

FIG. 1 is a schematic diagram of one non-limiting example of a system constructed and arranged to generate and measure two-photon-based fluorescence using IR wavelengths in a sample. The system 100 includes a light source apparatus 102 that is configured to produce a first pulse of supercontinuum light. As used herein, “supercontinuum light” refers to a white light source that spans a range of about 400 nm to about 2400 nm in the electromagnetic spectrum. The first pulse of supercontinuum light from the light source apparatus 102 is directed to a first beamsplitter 104 disposed in a path of the first pulse of supercontinuum light. The first beamsplitter 104 splits the first pulse of supercontinuum light into a first beam and a second beam. The first beam from the first beamsplitter 104 is directed into a first filter 106 that is tuned or positioned to pass a first IR light beam having a first IR wavelength range. The first IR light beam has its wavelength chosen to produce a population of triplet states in the sample.

In some embodiments, the first IR wavelength range may be from about 630 nm to about 800 nm, e.g., about 630 nm, about 640 nm, about 650 nm, about 660 nm, about 670 nm, about 680 nm, about 690 nm, about 700 nm, about 710 nm, about 720 nm, about 730 nm, about 740 nm, about 750 nm, about 760 nm, about 770 nm, about 780 nm, about 790 nm, or about 800 nm. The first filter 106 can be any suitable filter that can pass the first IR wavelength range from supercontinuum light. For example, the first filter 106 can be an acousto-optic tunable filter (AOTF), e.g., a filter including a single acousto-optic crystal, a single acoustic wave transducer bonded on a selected surface of the acousto-optic crystal and a radio frequency signal source, or a linear variable filter.

With continued reference to FIG. 1, the second beam of supercontinuum light formed from the first beamsplitter 104 is directed into a second filter 108 that is tuned or positioned to pass a second IR light beam having a second IR wavelength range. In some embodiments, the second IR wavelength range may be from about 800 nm to about 1000 nm, e.g., about 800 nm, about 810 nm, about 820 nm, about 830 nm, about 840 nm, about 850 nm, about 860 nm, about 870 nm, about 880 nm, about 890 nm, about 900 nm, about 910 nm, about 920 nm, about 930 nm, about 940 nm, about 950 nm, about 960 nm, about 970 nm, about 980 nm, about 990 nm, or about 1000 nm. The second filter 106 can be any suitable filter that can pass the second IR wavelength range from supercontinuum light. For example, the second filter 108 can be an AOTF or a linear variable filter. The second IR light beam has its wavelength chosen to produce a population of excited singlet states in the sample.

In some embodiments, the output power of one or both of the first IR light beam and the second IR light beam may be from about 1 kW/mm² to about 100 KW/mm², e.g., about 1 kW/mm² to about 10 kW/mm², about 5 kW/mm² to about 150 kW/mm², about 10 kW/mm² to about 30 kW/mm², about 20 kW/mm² to about 40 kW/mm², about 30 kW/mm² to about 50 kW/mm², about 40 kW/mm² to about 60 kW/mm², about 50 kW/mm² to about 70 kW/mm², about 60 kW/mm² to about 80 kW/mm², about 70 kW/mm² to about 90 kW/mm², or about 80 kW/mm² to about 100 kW/mm². In some embodiments, the output power of one or both of the first IR light beam and the second IR light beam may be about 1 kW/mm², about 2 kW/mm², about 3 kW/mm², about 4 kW/mm², about 5 kW/mm², about 6 kW/mm², about 7 kW/mm², about 8 kW/mm², about 9 kW/mm², about 10 kW/mm², 11 kW/mm², about 12 kW/mm², about 13 kW/mm², about 14 kW/mm², about 15 kW/mm², about 16 kW/mm², about 17 kW/mm², about 18 kW/mm², about 19 kW/mm², about 20 kW/mm², 12 kW/mm², about 22 kW/mm², about 23 kW/mm², about 24 kW/mm², about 25 kW/mm², about 26 kW/mm², about 27 kW/mm², about 28 kW/mm², about 29 kW/mm², about 30 kW/mm², 31 kW/mm², about 32 kW/mm², about 33 kW/mm², about 34 kW/mm², about 35 kW/mm², about 36 kW/mm², about 37 kW/mm², about 38 kW/mm², about 39 kW/mm², about 40 kW/mm², 41 kW/mm², about 42 kW/mm², about 43 kW/mm², about 44 kW/mm², about 45 kW/mm², about 46 kW/mm², about 47 kW/mm², about 48 kW/mm², about 49 kW/mm², about 50 kW/mm², 51 kW/mm², about 52 kW/mm², about 53 kW/mm², about 54 kW/mm², about 55 kW/mm², about 56 kW/mm², about 57 kW/mm², about 58 kW/mm², about 59 kW/mm², about 60 kW/mm², 61 kW/mm², about 62 kW/mm², about 63 kW/mm², about 64 kW/mm², about 65 kW/mm², about 66 kW/mm², about 67 kW/mm², about 68 kW/mm², about 69 kW/mm², about 70 kW/mm², 71 kW/mm², about 72 kW/mm², about 73 kW/mm², about 74 KW/mm², about 75 kW/mm², about 76 kW/mm², about 77 kW/mm², about 78 kW/mm², about 79 kW/mm², about 80 kW/mm², 81 kW/mm², about 82 kW/mm², about 83 kW/mm², about 84 kW/mm², about 85 kW/mm², about 86 kW/mm², about 87 kW/mm², about 88 kW/mm², about 89 kW/mm², about 90 kW/mm², 91 kW/mm², about 92 kW/mm², about 93 kW/mm², about 94 kW/mm², about 95 kW/mm², about 96 kW/mm², about 97 kW/mm², about 98 kW/mm², about 99 kW/mm², or about 100 kW/mm²

As disclosed herein, the first IR light beam and the second IR light beam are disposed to co-illuminate a sample that is positioned in front of an objective 112. To achieve co-illumination of the sample, the first IR light beam and the second IR light beam are combined using an optical assembly 110 positioned downstream of the first filter 106 and second filter 108 and illustrated in FIG. 1 with a dashed line box. The optical assembly 110 includes suitable optical components, such as one or more mirrors, lenses, dichroic filters, or combination thereof, and optionally one or more additional filters, polarizers, beamsplitters, or other optical components.

In some embodiments, the optical assembly 110 includes optical components constructed and arranged to permit scanning of the light beams. Scanning beams can be used for imaging, e.g., 2D or 3D imaging, of a sample or for the target stimulation of a specific or localized area of a sample. Optical components for scanning a light beam include, but are not limited to, scanning galvo mirrors, resonant scanners, acousto-optic deflectors, or stage scanning equipment, e.g., translational motors. These components can be positioned in the beam path of one or both IR light beams. In operation, scanning components within optical assembly 110 are constructed and arranged to scan the light beam across the sample in a raster, line, or a user-defined pattern to enable point-by-point excitation. Beam scanning can be synchronized with 1 detection to allow image formation or targeted stimulation of regions of interest.

In further embodiments, optical assembly 110 can include one or more components constructed and arranged to permit holographic patterning. Holography is used for generating arbitrary 2D or 3D excitation patterns. In particular, holography has shown utility for generating excitation patterns in multiphoton and optogenetic systems. With respect FIG. 1, one or both IR light beams may be patterned using a phase modulation device, such as a spatial light modulator (SLM) or digital micromirror device (DMD), to generate one or more holographic excitation foci within the sample. This modulation approach can be used to enable simultaneous multipoint stimulation or complex spatial excitation patterns.

Following interaction of the sample with the co-illuminated first IR light beam and the second IR light beam, e.g., the combined IR beam, the resulting effects, e.g., fluorescence, can be detected or observed. For systems 100 that do not include any specific detector, the resulting irradiation of the sample by the combined IR beam may be observed in a downstream process. For example, samples that do not fluoresce, phosphoresce, or otherwise emit photons upon irradiation with the combined IR beam may be polymerized, degraded, physically, and/or chemically altered or modified. As a non-limiting example, a photoresist that is sensitive to the combined IR beam will transfer the desired pattern to a substrate the photoresist is applied to upon irradiation with the combined IR beam without emitting photons. In other embodiments, such as that illustrated in FIG. 1, photon emissions may be observed by an IR detector 114 that is configured to receive a signal representative of fluorescence in the sample and to provide an output representative thereof. As further illustrated in FIG. 1, the system 100 can include any additional optics for directing the first IR light beam and the second IR light beam and the combined IR beam to the sample and the generated fluorescence to the IR detector 114, including one or more mirrors, periscopes, lenses, or combination thereof, and optionally one or more filters, polarizers, beamsplitters, or other optical components.

The first IR light beam and the second IR light beam can have a predetermined time delay between excitation due to the long-lived nature of triplet states. In some embodiments, the predetermined time delay may be from about 1 μs to about 1000 μs, e.g., about 1 μs to about 100 μs, about 10 μs to about 200 μs, about 20 μs to about 300 μs, about 30 μs to about 400 μs, about 40 μs to about 500 μs, about 50 μs to about 600 μs, about 60 μs to about 700 μs, about 70 μs to about 800 μs, about 80 μs to about 900 μs, or about 100 μs to about 1000 μs, e.g., about 1 μs, about 2 μs, about 3 μs, about 4 μs, about 5 μs, about 6 μs, about 7 μs, about 8 μs, about 9 μs, about 10 μs, about 20 μs, about 30 μs, about 40 μs, about 50 μs, about 60 μs, about 70 μs, about 80 μs, about 90 μs, about 100 μs, about 110 μs, about 120 μs, about 130 μs, about 140 μs, about 150 μs, about 160 μs, about 170 μs, about 180 μs, about 190 μs, about 200 μs, about 210 μs, about 220 μs, about 230 μs, about 240 μs, about 250 μs, about 260 μs, about 270 μs, about 280 μs, about 290 μs, about 300 μs, about 310 μs, about 320 μs, about 330 μs, about 340 μs, about 350 μs, about 360 μs, about 370 μs, about 380 μs, about 390 μs, about 400 μs, about 410 μs, about 420 μs, about 430 μs, about 440 μs, about 450 μs, about 460 μs, about 470 μs, about 480 μs, about 490 μs, about 500 μs, about 510 μs, about 520 μs, about 530 μs, about 540 μs, about 550 μs, about 560 μs, about 570 μs, about 580 μs, about 590 μs, about 600 μs, about 610 μs, about 620 μs, about 630 μs, about 640 μs, about 650 μs, about 660 μs, about 670 μs, about 680 μs, about 690 μs, about 700 μs, about 710 μs, about 720 μs, about 730 μs, about 740 μs, about 750 μs, about 760 μs, about 770 μs, about 780 μs, about 790 μs, about 800 μs, about 810 μs, about 820 μs, about 830 μs, about 840 μs, about 850 μs, about 860 μs, about 870 μs, about 880 μs, about 890 μs, about 900 μs, about 910 μs, about 920 μs, about 930 μs, about 940 μs, about 950 μs, about 960 μs, about 970 μs, about 980 μs, about 990 μs, or about 1000 μs, i.e., 1 μs.

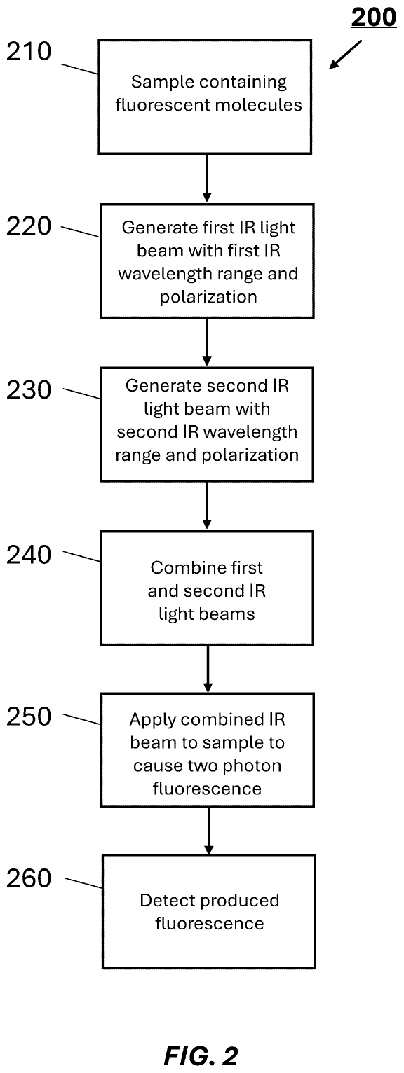

FIG. 2 illustrates a flow diagram of one non-limiting example of a method of irradiating a sample according to certain embodiments disclosed herein. The method 200 begins at step 200 with preparation of an initial sample, e.g., a sample containing molecules that can fluoresce under certain irradiation conditions. Suitable samples can include, but are not limited to, any inorganic, organic, or biological sample in an appropriate medium, such as fluorescent dyes, fluorescent biomolecules, photoresist chemicals, polymerizable resins, phosphors, acenes, coumarins, quantum dots, metal-organic frameworks (MOFs), and polymers. In some embodiments, a biological sample can be a living cell or a living organism, such as a laboratory animal. In step 220, a first IR light beam having a first IR wavelength range and a first polarization is generated from, e.g., the filtering of supercontinuum light using a suitable filter. In step 230, a second IR light beam having a second IR wavelength range and a second polarization is generated from, e.g., the filtering of supercontinuum light using a suitable filter. In some embodiments, the first polarization and the second polarization are identical. In other embodiments, the first polarization and the second polarization are different. In some embodiments, one or both of the first polarization and the second polarization may be azimuthal. For example, the first polarization may be azimuthal and the second polarization may be different. In other embodiments, the second polarization may be azimuthal and the first polarization may be different.

In step 240, the first IR light beam and the second IR light beam are combined, e.g., using a suitable optical assembly, to form a combined IR light beam that is directed to the sample. The combined IR light beam can spatially co-illuminate the sample where the first IR light beam and the second IR light beam are temporally separated by the lifetime of the triplet states formed when the first IR light beam excites the magnetic dipole transitions in the sample. The combined IR light beam is applied to the sample at step 250 to trigger two-photon processes in the sample, e.g., transitions from the S₀ state to the T₁ state using excitation of magnetic dipole transitions using the first IR light beam and transitions from the T₁ state to the S₁ state via population of higher energy transient Tₙ states with the second IR light beam and RISC down to the S₁ state. The emissions from this IR two-photon excitation process are detected by a suitable photosensitive detector at step 260.

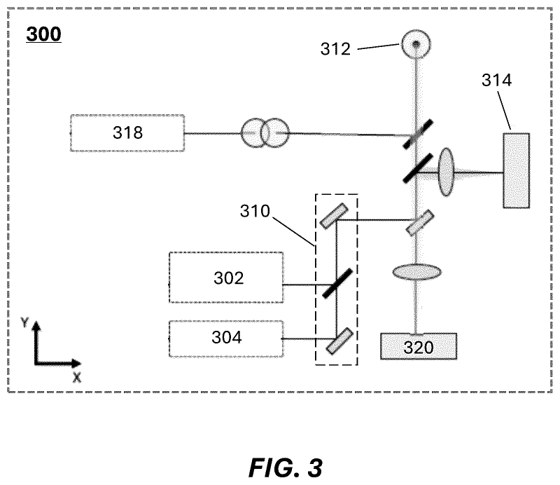

FIG. 3 is a schematic diagram of another non-limiting example of a system constructed and arranged to generate and measure two-photon-based fluorescence using visible and IR wavelengths in a sample. The system 300 includes a first light source 302 configured to produce a visible light beam having a first visible wavelength range. The visible light beam has its wavelength chosen to produce a population of triplet states in the sample. The first light source apparatus 302 can be a fixed frequency source of visible light. Alternatively, the first light source apparatus 302 can be a tunable frequency source of visible light, such as a supercontinuum light source. System 300 further includes a second light source 304 configured to produce an infrared (IR) light beam having an IR wavelength range. The IR light beam has its wavelength chosen to produce a population of excited singlet states in the sample. The second light source 304 can be a fixed frequency source of IR light. Alternatively, the second light source 304 can be a tunable frequency source of IR light.

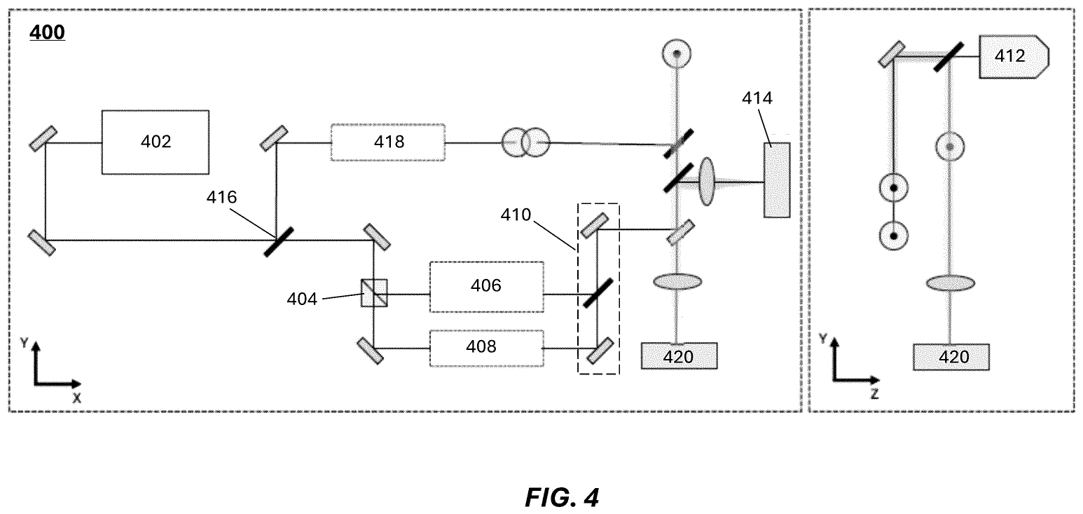

FIG. 4 is a schematic diagram of another non-limiting example of a system constructed and arranged to generate and measure two-photon-based fluorescence using visible and IR wavelengths in a sample. The system 400 includes a light source apparatus 402 that is configured to produce a first pulse of supercontinuum light. The first pulse of supercontinuum light from the light source apparatus 402 is directed to a first beamsplitter 404 disposed in a path of the first pulse of supercontinuum light. The first beamsplitter 404 splits the first pulse of supercontinuum light into a first beam and a second beam. The first beam from the first beamsplitter 404 is directed into a first filter 406 that is tuned or positioned to pass a first visible light beam having a visible wavelength range. The visible light beam has its wavelength chosen to produce a population of triplet states in the sample.

In some embodiments of the systems disclosed in FIGS. 3 and 4, the visible wavelength range may be from about 400 nm to about 700 nm, e.g., about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, or about 700 nm. The first filter 406 can be any suitable filter that can pass the first IR wavelength range from supercontinuum light. For example, the first filter 406 can be an acousto-optic tunable filter (AOTF), e.g., a filter including a single acousto-optic crystal, a single acoustic wave transducer bonded on a selected surface of the acousto-optic crystal and a radio frequency signal source, or a linear variable filter.

With continued reference to FIG. 4, the second beam of supercontinuum light formed from the first beamsplitter 404 is directed into a second filter 408 that is tuned or positioned to pass an IR light beam having an IR wavelength range. In some embodiments of the systems disclosed in FIGS. 3 and 4, the second IR wavelength range may be from about 750 nm to about 1000 nm, e.g., about 750 nm, about 760 nm, about 770 nm, about 780 nm, about 790 nm, about 800 nm, about 810 nm, about 820 nm, about 830 nm, about 840 nm, about 850 nm, about 860 nm, about 870 nm, about 880 nm, about 890 nm, about 900 nm, about 910 nm, about 920 nm, about 930 nm, about 940 nm, about 950 nm, about 960 nm, about 970 nm, about 980 nm, about 990 nm, or about 1000 nm. The second filter 408 can be any suitable filter that can pass the IR wavelength range from supercontinuum light. For example, the second filter 408 can be an AOTF or a linear variable filter. The IR light beam has its wavelength chosen to produce a population of excited singlet states in the sample.

In some embodiments of the systems disclosed in FIGS. 3 and 4, the output power of one or both of the visible light beam and the IR light beam may be from about 1 kW/mm² to about 100 kW/mm², e.g., about 1 kW/mm² to about 10 kW/mm², about 5 kW/mm² to about 150 kW/mm², about 10 kW/mm² to about 30 kW/mm², about 20 kW/mm² to about 40 kW/mm², about 30 kW/mm² to about 50 kW/mm², about 40 kW/mm² to about 60 kW/mm², about 50 kW/mm² to about 70 kW/mm², about 60 kW/mm² to about 80 kW/mm², about 70 kW/mm² to about 90 kW/mm², or about 80 kW/mm² to about 100 KW/mm². In some embodiments, the output power of one or both of the second light beam and the IR light beam may be about 1 kW/mm², about 2 kW/mm², about 3 kW/mm², about 4 kW/mm², about 5 kW/mm², about 6 kW/mm², about 7 kW/mm², about 8 kW/mm², about 9 kW/mm², about 10 kW/mm², 11 kW/mm², about 12 kW/mm², about 13 kW/mm², about 14 kW/mm², about 15 kW/mm², about 16 kW/mm², about 17 kW/mm², about 18 kW/mm², about 19 kW/mm², about 20 kW/mm², 12 kW/mm², about 22 kW/mm², about 23 kW/mm², about 24 kW/mm², about 25 kW/mm², about 26 kW/mm², about 27 kW/mm², about 28 kW/mm², about 29 kW/mm², about 30 kW/mm², 31 kW/mm², about 32 kW/mm², about 33 kW/mm², about 34 kW/mm², about 35 kW/mm², about 36 kW/mm², about 37 kW/mm², about 38 kW/mm², about 39 kW/mm², about 40 kW/mm², 41 kW/mm², about 42 kW/mm², about 43 kW/mm², about 44 kW/mm², about 45 kW/mm², about 46 kW/mm², about 47 kW/mm², about 48 kW/mm², about 49 kW/mm², about 50 kW/mm², 51 kW/mm², about 52 kW/mm², about 53 kW/mm², about 54 kW/mm², about 55 kW/mm², about 56 kW/mm², about 57 kW/mm², about 58 kW/mm², about 59 kW/mm², about 60 kW/mm², 61 kW/mm², about 62 kW/mm², about 63 kW/mm², about 64 kW/mm², about 65 kW/mm², about 66 kW/mm², about 67 kW/mm², about 68 kW/mm², about 69 kW/mm², about 70 kW/mm², 71 kW/mm², about 72 kW/mm², about 73 kW/mm², about 74 kW/mm², about 75 kW/mm², about 76 kW/mm², about 77 kW/mm², about 78 kW/mm², about 79 kW/mm², about 80 kW/mm², 81 kW/mm², about 82 kW/mm², about 83 kW/mm², about 84 kW/mm², about 85 kW/mm², about 86 kW/mm², about 87 kW/mm², about 88 kW/mm², about 89 kW/mm², about 90 kW/mm², 91 kW/mm², about 92 kW/mm², about 93 kW/mm², about 94 kW/mm², about 95 kW/mm², about 96 kW/mm², about 97 kW/mm², about 98 kW/mm², about 99 kW/mm², or about 100 kW/mm².

With continued reference to FIGS. 3 and 4, the visible light beam and the IR light beam are disposed to co-illuminate a sample that is positioned in front of an objective 312/412. To achieve co-illumination of the sample, the first light beam and the second light beam are combined using an optical assembly 310/410 and illustrated in FIGS. 3 and 4 with a dashed line box. In FIG. 4, the optical assembly 410 is positioned downstream of the first light source apparatus 402. The optical assembly 310/410 includes suitable optical components, such as one or more mirrors, lenses, dichroic filters, or combination thereof, and optionally one or more additional filters, polarizers, beamsplitters, or other optical components.

In some embodiments, the optical assembly 310/410 includes optical components constructed and arranged to permit scanning of the light beams. Optical components for scanning a light beam include, but are not limited to, scanning galvo mirrors, resonant scanners, acousto-optic deflectors, or stage scanning equipment, e.g., translational motors. These components can be positioned in the beam path of one or both IR light beams. In operation, scanning components within optical assembly 310/410 are constructed and arranged to scan the light beam across the sample in a raster, line, or a user-defined pattern to enable point-by-point excitation. Beam scanning can be synchronized with detection to allow image formation or targeted stimulation of regions of interest.

In further embodiments, optical assembly 310/410 can include one or more components constructed and arranged to permit holographic patterning. With respect FIG. 3/4, one or both light beams may be patterned using a phase modulation device, such as a spatial light modulator (SLM) or digital micromirror device (DMD), to generate one or more holographic excitation foci within the sample. This modulation approach can be used to enable simultaneous multipoint stimulation or complex spatial excitation patterns.

Following interaction of the sample with the co-illuminated visible light beam and the IR light beam, the resulting effects, e.g., fluorescence, can be detected or observed. For systems 300/400 that do not include any specific detector, the resulting irradiation of the sample by the combined beam may be observed in a downstream process. For example, samples that do not fluoresce, phosphoresce, or otherwise emit photons upon irradiation with the combined beam may be polymerized, degraded, physically, and/or chemically altered or modified. As a non-limiting example, a photoresist that is sensitive to the combined beam will transfer the desired pattern to a substrate the photoresist is applied to upon irradiation with the combined beam without emitting photons. In other embodiments, such as that illustrated in FIGS. 3 and 4, photon emissions may be observed by a detector 314/414 that is configured to receive a signal representative of fluorescence in the sample and to provide an output representative thereof. As further illustrated in FIGS. 3 and 4, the system 300/400 can include any additional optics for directing the visible light beam and the IR light beam and the combined beam to the sample and the generated fluorescence to the detector 314/414, including one or more mirrors, periscopes, lenses, or combination thereof, and optionally one or more filters, polarizers, beamsplitters, or other optical components.

The visible light beam and the IR light beam produced in the systems illustrated in FIGS. 3 and 4 can have a predetermined time delay between excitation due to the long-lived nature of triplet states. In some embodiments, the predetermined time delay may be from about 1 μs to about 1000 μs, e.g., about 1 μs to about 100 μs, about 10 μs to about 200 μs, about 20 μs to about 300 μs, about 30 μs to about 400 μs, about 40 μs to about 500 μs, about 50 μs to about 600 μs, about 60 μs to about 700 μs, about 70 μs to about 800 μs, about 80 μs to about 900 μs, or about 100 μs to about 1000 μs, e.g., about 1 μs, about 2 μs, about 3 μs, about 4 μs, about 5 μs, about 6 μs, about 7 μs, about 8 μs, about 9 μs, about 10 μs, about 20 μs, about 30 μs, about 40 μs, about 50 μs, about 60 μs, about 70 μs, about 80 μs, about 90 μs, about 100 μs, about 110 μs, about 120 μs, about 130 μs, about 140 μs, about 150 μs, about 160 μs, about 170 μs, about 180 μs, about 190 μs, about 200 μs, about 210 μs, about 220 μs, about 230 μs, about 240 μs, about 250 μs, about 260 μs, about 270 μs, about 280 μs, about 290 μs, about 300 μs, about 310 μs, about 320 μs, about 330 μs, about 340 μs, about 350 μs, about 360 μs, about 370 μs, about 380 μs, about 390 μs, about 400 μs, about 410 μs, about 420 μs, about 430 μs, about 440 μs, about 450 μs, about 460 μs, about 470 μs, about 480 μs, about 490 μs, about 500 μs, about 510 μs, about 520 μs, about 530 μs, about 540 μs, about 550 μs, about 560 μs, about 570 μs, about 580 μs, about 590 μs, about 600 μs, about 610 μs, about 620 μs, about 630 μs, about 640 μs, about 650 μs, about 660 μs, about 670 μs, about 680 μs, about 690 μs, about 700 μs, about 710 μs, about 720 μs, about 730 μs, about 740 μs, about 750 μs, about 760 μs, about 770 μs, about 780 μs, about 790 μs, about 800 μs, about 810 μs, about 820 μs, about 830 μs, about 840 μs, about 850 μs, about 860 μs, about 870 μs, about 880 μs, about 890 μs, about 900 μs, about 910 μs, about 920 μs, about 930 μs, about 940 μs, about 950 μs, about 960 μs, about 970 μs, about 980 μs, about 990 μs, or about 1000 μs, i.e., 1 μs.

As disclosed herein, in at least one embodiment, any light beam in any system disclosed herein, e.g., one or both of the first IR light beam and the second IR light beam or one or both of the visible light beam and the IR light beam, can have azimuthal polarization. As used herein, azimuthal polarization refers to polarization around the axis of propagation with an electric field purely transverse to the beam axis. To form azimuthal polarized beams, systems 100, 300, and 400 can include suitable optics disposed before the optical assembly 110, 310, and 410. For example, system 100, 300, and 400 include segmented half-wave plates, spiral phase plates, or liquid crystal plates to produce azimuthal polarized beams from one or both of the first IR light beam and the second IR light beam. Without wishing to be bound by any particular theory, spiral phase plates can be used to shape a linearly polarized light beam into a Laguerre Gaussian beam with azimuthal polarization. In some embodiments, when one of the first IR light beam and the second IR light beam have azimuthal polarization, the other IR light beam may have a different polarization. For example, one or both of the first IR light beam and the second IR light beam can have linear polarization, circular polarization, or elliptical polarization.

Typical two-photon microscopy excites a fluorescent molecule from the ground state (S₀) to the first excited singlet state (S₁) by transiently populating a virtual state in between with infrared photons. As disclosed herein, directly accessing the first excited triplet state (T₁), which is lower in energy than the S₁ state, from the S₀ state can be achieved using IR wavelengths with one or both of higher light source power or IR light beams that have the transverse profile of the incident light shaped to better match the magnetic dipole transition selection rules, e.g., azimuthal polarization as disclosed herein. In further embodiments, directly accessing the T₁ state from the S₀ state can be achieved using visible wavelengths. In any embodiment discloses herein, a population of a first triplet states in the sample can be produced via excitation of a ground state in the sample and a population of excited singlet states derived from relaxation of a population of higher order triplet states in the sample.

In the systems disclosed herein, the population of triplet states in the fluorescent molecules in the sample is produced by exciting magnetic dipole transitions in the fluorescent molecules using the first IR light beam or a visible beam. Once the population of triplet states is produced from the excitation of magnetic dipole transitions in the sample, the population of excited singlet can be produced by using the second IR beam to populate transient higher level excited triplet states higher in energy than the population of triplet states. As disclosed herein, reverse intersystem crossing (RISC) is a process of energy transfer from triplet states to excited singlet states. Generally, RISC occurs from the T₁ state to the S₁ of a molecule according to Kasha's Rule but has also been shown to occur between higher level excited triplet states (Tₙ) and the S₁ state. By populating higher level excited triplet states Tₙ using excitation via the second IR light beam, those states can relax through RISC to produce the population of excited singlet states, thus providing a mechanism for studying transitions typically “forbidden” by electric dipole selection rules.

With continued reference to FIGS. 1 and 4, systems 100, 400 include a second beamsplitter 116, 416 disposed in the path of the first pulse of supercontinuum light to produce a third beam of supercontinuum light. As illustrated, the second beamsplitter 116, 416 is positioned upstream of the first beamsplitter 104, 404 to produce a separate beam, e.g., the third beam of supercontinuum light, remote from those produced by the first beamsplitter 104, 404. The third beam of supercontinuum light produced from the second beamsplitter 116, 416 is directed into a third filter 118, 418 to pass a visible light beam. The third filter 118, 418 can be any suitable filter that can pass visible light, e.g., in a specified wavelength range, from supercontinuum light. For example, the third filter 118, 418 can be an AOTF or a linear variable filter. The visible light beam produced from the third filter 118, 418 has its wavelength chosen to produce traditional fluorescence, e.g., a S₀ state to S₁ state transition with return to the S₀ state on the order of nanoseconds via emission. To detect visible light fluorescence, systems 100, 400 include a visible light detector 120, 420 configured to receive a signal representative of fluorescence in the sample and to provide an output representative thereof. The visible light beam portion of systems 100, 400 includes additional optical equipment consistent with epifluorescence microscopy instruments including, but not limited to, dichroic filters, telescopes, microscope objectives, tube lenses, and imaging cameras positioned in a downright orientation.

In some embodiments, the visible light beam, e.g., from the third filter 118, 418 may have a wavelength range from about 400 nm to about 630 nm, e.g., about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, or about 630 nm.

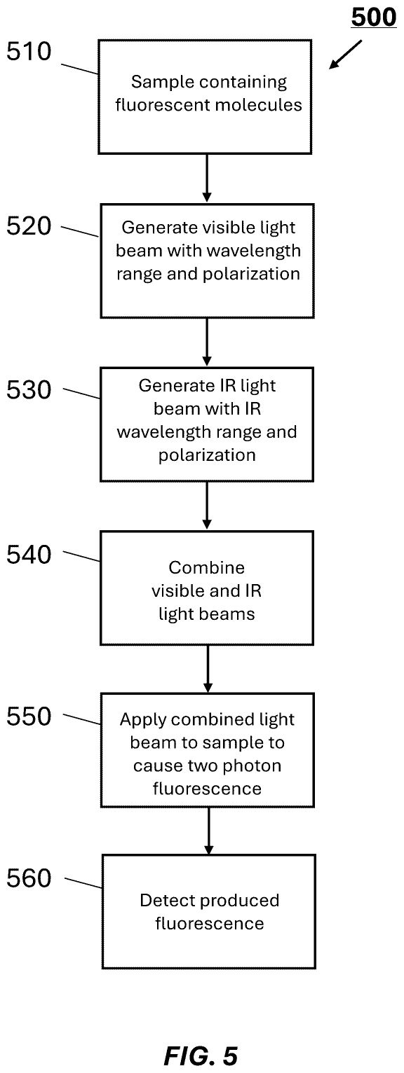

FIG. 5 illustrates a flow diagram of one non-limiting example of a method of irradiating a sample according to certain embodiments disclosed herein. The method 500 begins at step 500 with preparation of an initial sample, e.g., a sample containing molecules that can fluoresce under certain irradiation conditions. Suitable samples can include, but are not limited to, any inorganic, organic, or biological sample in an appropriate medium, such as fluorescent dyes, fluorescent biomolecules, photoresist chemicals, polymerizable resins, phosphors, acenes, coumarins, quantum dots, metal-organic frameworks (MOFs), and polymers. In some embodiments, a biological sample can be a living cell or a living organism, such as a laboratory animal. In step 520, a visible light beam having a visible wavelength range and a first polarization is generated from, e.g., the filtering of supercontinuum light using a suitable filter. In step 530, an IR light beam having an IR wavelength range and a second polarization is generated from, e.g., the filtering of supercontinuum light using a suitable filter. In some embodiments, the first polarization and the second polarization are identical. In other embodiments, the first polarization and the second polarization are different. In some embodiments, one or both of the first polarization and the second polarization may be azimuthal. For example, the first polarization may be azimuthal and the second polarization may be different. In other embodiments, the second polarization may be azimuthal and the first polarization may be different.

In step 540, the visible light beam and the IR light beam are combined, e.g., using a suitable optical assembly, to form a combined light beam that is directed to the sample. The combined light beam can spatially co-illuminate the sample where the visible light beam and the IR light beam are temporally separated by the lifetime of the triplet states formed when the visible light beam excites certain transitions in the sample. The combined light beam is applied to the sample at step 550 to trigger two-photon processes in the sample, e.g., transitions from the S₀ state to the T₁ state using the visible light beam and transitions from the T₁ state to the S₁ state via population of higher energy transient Tₙ states with the IR light beam and RISC down to the S₁ state. The emissions from this VIS-IR two-photon excitation process are detected by a suitable photosensitive detector at step 560.

In some embodiments, systems disclosed herein may be used in a single color configuration. In this configuration, systems with multiple fixed frequency light source apparatus, e.g., system 300 of FIG. 3, can be arranged to only use one light source apparatus at one frequency. In another embodiment, systems including a supercontinuum light source apparatus can be operated such only one wavelength of light is directed to the sample. For example, in supercontinuum light source-based systems, e.g., system 100 and 400 of FIGS. 1 and 4, the output from the supercontinuum light source apparatus can be directed to a filter instead of a beamsplitter to produce a single wavelength. In another embodiment, the system include a light source configured to produce a light beam having a wavelength range to produce a population of excited singlet states derived from relaxation of a population of higher order triplet states in the sample. The system includes an optical assembly constructed and arranged to direct the light beam. The system further includes a first objective constructed and arranged to irradiate the sample with the light beam. Other configurations of single color operation of systems disclosed herein are within the scope of this disclosure.

In some embodiments, the light source is a visible light source. When the light source is a visible light source, the visible wavelength range may be between about 400 nm to about 700 nm.

In some embodiments, the light source is an infrared (IR) light source. When the light source is an IR light source, the IR wavelength range may be between about 750 nm to about 1000 nm.

In some embodiments, the light source is a pulsed light source or a continuous wave (CW) light source. Continuous wave light beam can be externally modulated using electro-optic modulators (EOMs) or acousto-optic modulators (AOMs) to produce pulses in a different manner than a typical pulsed laser. EOMs are optical devices that have an adjustable refractive index upon application of an electric field. The variable refractive index can modulate beam properties, e.g., amplitude, phase, or polarization. AOMs are optical devices that have include a crystalline or glass material connected to a piezoelectric transducer. As the piezoelectric transducer is driven by RF, sound waves are produced that cause incident CE light to diffract, thereby modulating the CW beam. In some embodiments, the light source used in any system disclosed herein can be a CW light source that includes an external modulation system. The external modulation system can be arranged to a sequence of modulated light pulses from the CW light source. For example, the light source, whether pulsed or continuous wave, is a fixed wavelength light source. Alternatively, the light source, whether pulsed or continuous wave, is a supercontinuum light source. When the light source is a supercontinuum light source, the wavelength range from the supercontinuum light source is set using a filter. The filter for the supercontinuum light source is an acousto-optic tunable filter or a linear variable filter.

In some embodiments, a signal representative of fluorescence in the sample is collected by the first objective.

In further embodiments, the system includes a second objective constructed and arranged to collect a signal representative of fluorescence in the sample.

In further embodiments, the system includes a detector constructed and arranged to receive the signal representative of fluorescence in the sample and to provide an output representative thereof.

In accordance with an aspect, there is provided a method of irradiating a sample. The method includes generating a light beam having a wavelength range chosen to produce a population of excited singlet states derived from relaxation of a population of higher order triplet states in the sample. The method includes applying the light beam to the sample using an objective to produce a population of triplet states and a population of excited singlet states in the sample.

In further embodiments, the method includes detecting fluorescence from the sample. Detecting fluorescence from the sample includes receiving fluorescent emissions from relaxation of the population of excited singlet states in the sample at a photosensitive detector.

In some embodiments, the light source is a visible light source. When the light source is a visible light source, the visible wavelength range is between about 400 nm to about 700 nm.

In some embodiments, the light source is an infrared (IR) light source. When the light source is an IR light source, the IR wavelength range is between about 750 nm to about 1000 nm.

In some embodiments, the light source is a pulsed light source or a continuous wave light source. For example, the light source, whether pulsed or continuous wave, e.g., with or without external modulation, is a fixed wavelength light source. Alternatively, the light source, whether pulsed or continuous wave, is a supercontinuum light source. When the light source is a supercontinuum light source, the wavelength range from the supercontinuum light source is set using a filter. The filter for the supercontinuum light source is an acousto-optic tunable filter or a linear variable filter.

### EXAMPLES

The function and advantages of these and other embodiments of this disclosure can be better understood from the following examples. These examples are intended to be illustrative in nature and are not considered to be in any way limiting the scope of the invention.

### Prophetic Example 1

In this prophetic example, experiments that will be used to demonstrate optical magnetic dipole transitions in fluorescent proteins with free space optics are described.

The proposed experiments will demonstrate direct excitation to the first excited triplet state in fluorescent molecules. The system will utilize a supercontinuum laser providing broad light across the 400 to 1000 nm band. For sample characterization and instrument testing, the visible portion of the spectrum (about 400-630 nm) will be separated from the infrared portion (about 630-1000 nm) of the spectrum. The separated visible light will be directed to samples of fluorescent dyes or proteins that are embedded in polyacrylamide (PAA) or polyvinyl alcohol (PVA) gels to constrain molecular diffusion. The visible light path will incorporate typical epifluorescence microscopy elements such as dichroic filters, objectives, tube lenses, and cameras in a downright orientation.

The separated infrared light beam will be split into two separate beams: a first IR beam (IR1) with a wavelength range of about 630-800 nm and a second IR light beam (IR2) with a wavelength range of about 800-1000 nm. Initial experiments will use a single IR beam to excite the triplet state in the sample. For enhanced Green Fluorescent Protein (eGFP) and Erythrosine B (ErB), the known phosphorescence peaks at 725 nm and 660 nm, respectively, will be used for the IR excitation using Gaussian TEM₀₀ modes blue-detuned by 20 and 28 nm, respectively. Due to the low probability of magnetic dipole transitions, this approach may require higher laser power than typical S₀→S₁ transitions.

To reduce laser power and energy costs, the transverse profile of the incident IR beam will be shaped to better match the magnetic dipole transition selection rules. The linearly polarized Gaussian IR beams will be shaped into azimuthally polarized IR beams using liquid crystal plates that will create a zero electric field at the center of the beam but a maximum magnetic field along the axis of beam propagation. It is anticipated that appropriate beam shaping can lower the required optical power by relaxing the electric dipole selection rules, enabling direct excitation of the triplet state as an intermediate step in a two-photon process. Successful population of the triplet state will be evidenced by decreased fluorescence when exciting the sample with the visible light beam due to population trapping in the dark triplet state.

The second step of the proposed experiment, transitioning from the excited triplet (T₁) state to the excited singlet (S₁) state, will be achieved using the second IR light beam. The T₁ to S₁ transition requires several orders of magnitude less light intensity than typical two-photon processes using femtosecond lasers (about 1 kW/cm² vs. thousands of kW/cm²). This transition is indirect, involving the transient population of higher excited triplet (Tₙ) states and RISC to S₁.

### Prophetic Example 2

In this prophetic example, some potential exemplary uses of magnetic dipole excitation induced fluorescence are discussed.

Systems akin to the design illustrated in FIG. 1 are designed to replace current cutting-edge microscopes by having reduced costs, lower power consumption, and increased portability. Current two-photon microscopes, the present state of the art, consume substantial amounts of power for the laser system, weigh over 100 pounds, require wired infrastructure to operate, and cost over $1,000,000 at retail. Considering economy of scale production, the systems described herein are expected to have a cost of about $35,000 and a mass of about 10 g. The reduced costs and minimal overhead infrastructure required to operate the systems disclosed herein are expected to appeal to both commercial and academic users, e.g., industrial materials laboratories, pharmaceutical companies, and academic life sciences laboratories.

In particular, systems and methods disclosed herein are further expected to expand the frontiers of neurotechnology by allowing novel applications for interfacing with human subjects e.g. holographic stimulation of opsins. Further, systems and methods disclosed herein would open avenues in experimental and theoretical physical chemistry by allowing a new dimension of chemical and protein analysis via measuring direct interactions with molecular spin rather than the traditional approach of probing molecular orbitals and vibrational levels. Insights and techniques to measure internal molecular structures are expected to advance the creation of new small molecule pharmaceutical products.

Additional applications of systems and methods disclosed herein are in the use of photoresist chemicals in lithographic applications, such as in the manufacture of integrated circuits or other industrial processes where designs are affixed to a substate upon irradiation with light. Two-photon lithography at scale is presently bottlenecked by speed and processing volumes. It is anticipated that continuous wave lasers, which are less expensive, have a smaller footprint, and have lower power requirements than the femtosecond pulsed lasers that current 2-photon lithography systems utilize, can facilitate the ability to scale up two-photon lithography. For example, anticipated scaling could be achieved by incorporating increased numbers of lasers to parallelize lithographic processes and/or by simple reduction in capital expenditures. Further, typical UV photoresist processes have low penetration depth into a substrate, e.g., most UV photochemical reactions occur only at the surface part of photoresist, and the bottom part of photoresist cannot receive enough photon energy. This causes a mountain shaped tapered profile for positive photoresist and an overhung shape for negative photoresist. Stronger exposure, i.e., using higher light intensity lamps or longer exposure time, can reduce this phenomenon but has the drawback of increased power consumption. The use of IR-sensitive photoresists for lithography can result in deeper penetration into the substrate, potentially resulting in high photoresist photosensitivity and the resulting cured photoresist profile would be more vertical even with high film thickness. A new two-photon lithography method using IR photons may have applications in fabricating micro-electromechanical devices, photonic and optoelectronic devices, and bioengineering devices.

Other applications for systems and methods disclosed herein include quantum computing, e.g., optical quantum computing, where resonant energy transfer upon irradiation can be used to control particle states. In trapped ion quantum computers, the ability to drive transitions between hyperfine qubits requires either microwave fields or exploiting Raman transitions. Atomic transitions mediated by microwaves can be made high fidelity, but tend to be slow, e.g., several microseconds, compared to Raman transitions, which occur in picoseconds. The fidelity of Raman transitions has been limited by the transient population of excited states, leading to spontaneous emission and decreasing the ultimate fidelity of the operation. The ability to drive hyperfine transitions with optical fields without exciting other states would be transformative for both speed and fidelity. A scheme where two azimuthally polarized light fields irradiate an atomic ion and are detuned in frequency to match the transition line could be transformative to both increase the fidelity and speed of quantum gates by driving magnetic dipole transitions.

### Prophetic Example 3

In this prophetic example, experiments that will be used to demonstrate optical magnetic dipole transitions in fluorescent proteins with free space optics are described.

The proposed experiments will demonstrate direct excitation to the first excited triplet state in fluorescent molecules. The system will utilize a supercontinuum laser providing broad light across the 400 to 1000 nm band. For sample characterization and instrument testing, the visible portion of the spectrum (about 400-630 nm) will be separated from the infrared portion (about 630-1000 nm) of the spectrum. The separated visible light will be directed to samples of fluorescent dyes or proteins that are embedded in polyacrylamide (PAA) or polyvinyl alcohol (PVA) gels to constrain molecular diffusion. The visible light path will incorporate typical epifluorescence microscopy elements such as dichroic filters, objectives, tube lenses, and cameras in a downright orientation.

The separated infrared light beam will be split into two separate beams: a first IR beam (IR1) with a wavelength range of about 630-800 nm and a second IR light beam (IR2) with a wavelength range of about 800-1000 nm. Initial experiments will use a single IR beam to excite the triplet state in the sample. For enhanced Green Fluorescent Protein (eGFP) and Erythrosine B (ErB), the known phosphorescence peaks at 725 nm and 660 nm, respectively, will be used for the IR excitation using Gaussian TEM₀₀ modes blue-detuned by 20 nm and 28 nm, respectively. Due to the low probability of magnetic dipole transitions, this approach may require higher laser power than typical S₀→S₁ transitions.

To reduce laser power and energy costs, the transverse profile of the incident IR beam will be shaped to better match the magnetic dipole transition selection rules. The linearly polarized Gaussian IR beams will be shaped into azimuthally polarized IR beams using liquid crystal plates that will create a zero electric field at the center of the beam but a maximum magnetic field along the axis of beam propagation. It is anticipated that appropriate beam shaping can lower the required optical power by relaxing the electric dipole selection rules, enabling direct excitation of the triplet state as an intermediate step in a two-photon process. Successful population of the triplet state will be evidenced by decreased fluorescence when exciting the sample with the visible light beam due to population trapping in the dark triplet state.

The second step of the proposed experiment, transitioning from the excited triplet (T₁) state to the excited singlet (S₁) state, will be achieved using the second IR light beam. The T₁ to S₁ transition requires several orders of magnitude less light intensity than typical two-photon processes using femtosecond lasers (about 1 kW/cm² vs. thousands of kW/cm²). This transition is indirect, involving the transient population of higher excited triplet (Tₙ) states and RISC to S₁.

### Prophetic Example 4

In this prophetic example, some potential exemplary uses of magnetic dipole excitation induced fluorescence are discussed.

Systems akin to the embodiments illustrated in FIGS. 1, 3, and 4 are designed to replace current cutting-edge microscopes by having reduced capital expenditure and operating costs, lower power consumption, and increased portability. Current two-photon microscopes, the present state of the art, consume substantial amounts of power for the laser system, weigh over 100 pounds, require wired infrastructure to operate, and cost over $1,000,000 at retail. Considering economy of scale production, the systems described herein are expected to have a cost of about $35,000 and a mass of about 10 g. The reduced costs and minimal overhead infrastructure required to operate the systems disclosed herein are expected to appeal to both commercial and academic users, e.g., industrial materials laboratories, pharmaceutical companies, and academic life sciences laboratories.

In particular, systems and methods disclosed herein are further expected to expand the frontiers of neurotechnology by allowing novel applications for interfacing with human subjects e.g., holographic stimulation of opsins. When introduced into non-light-sensitive cells, opsins enable rapid optical control of specific cellular processes. Opsins offer high speed neural activation and silencing without requiring the use of chemicals in the mammalian brain. As IR radiation penetrates deeper into tissues compared to other photons and is less damaging to sensitive biological samples, the use of systems disclosed herein can provide detailed knowledge of opsin behavior under two-photon illumination, paving the way for achieving in depth remote control of multiple cells with high spatiotemporal resolution deep within scattering tissue at lower cost that current state of the art microscopy systems. Further, systems and methods disclosed herein would open avenues in experimental and theoretical physical chemistry by allowing a new dimension of chemical and protein analysis via measuring direct interactions with molecular spin rather than the traditional approach of probing molecular orbitals and vibrational levels. Insights and techniques to measure internal molecular structures are expected to advance the creation of new small molecule pharmaceutical products.

Additional applications of systems and methods disclosed herein are in the use of photoresist chemicals in lithographic applications, such as in the manufacture of integrated circuits or other industrial processes where designs are affixed to a substate upon irradiation with light. Two-photon lithography at scale is presently bottlenecked by speed and processing volumes. It is anticipated that continuous wave lasers, which are less expensive, have a smaller footprint, and have lower power requirements than the femtosecond pulsed lasers that current 2-photon lithography systems utilize, can facilitate the ability to scale up two-photon lithography. For example, anticipated scaling could be achieved by incorporating increased numbers of lasers to parallelize lithographic processes and/or by simple reduction in capital expenditures. Further, typical UV photoresist processes have low penetration depth into a substrate, e.g., most UV photochemical reactions occur only at the surface part of photoresist, and the bottom part of photoresist cannot receive enough photon energy. This causes a mountain shaped tapered profile for positive photoresist and an overhung shape for negative photoresist. Stronger exposure, i.e., using higher light intensity lamps or longer exposure time, can reduce this phenomenon but has the drawback of increased power consumption. The use of IR-sensitive photoresists for lithography can result in deeper penetration into the substrate, potentially resulting in high photoresist photosensitivity and the resulting cured photoresist profile would be more vertical even with high film thickness. A new two-photon lithography method using IR photons may have applications in fabricating micro-electromechanical devices, photonic and optoelectronic devices, and bioengineering devices.

Recent evidence has suggested that label-free two photon imaging has utility for the assessment of biological tissues. Label-free multiphoton imaging is an optical technique that retrieves morphological and chemical information on the imaged target avoiding all staining and that can potentially be performed in real-time. All mammalian cells contain endogenous fluorophores, e.g., nicotinamide adenine dinucleotide phosphate (NAD (P) H) and flavin adenine dinucleotide (FAD), such that examination of unstained tumor slides using two photon processes is a possible route to fulfill this goal. As IR radiation penetrates deeper into tissues compared to other photons and is less damaging to sensitive biological samples, the use of systems disclosed herein can provide real-time imaging of delicate biological structures with resolution sufficient to distinguish tissue types at a lower cost than current state of the art microscopy systems.

Other applications for systems and methods disclosed herein include quantum computing, e.g., optical quantum computing, where resonant energy transfer upon irradiation can be used to control particle states. In trapped ion quantum computers, the ability to drive transitions between hyperfine qubits requires either microwave fields or exploiting Raman transitions. Atomic transitions mediated by microwaves can be made high fidelity, but tend to be slow, e.g., several microseconds, compared to Raman transitions, which occur in picoseconds. The fidelity of Raman transitions has been limited by the transient population of excited states, leading to spontaneous emission and decreasing the ultimate fidelity of the operation. The ability to drive hyperfine transitions with optical fields without exciting other states would be transformative for both speed and fidelity. A scheme where two azimuthally polarized light fields irradiate an atomic ion and are detuned in frequency to match the transition line could be transformative to both increase the fidelity and speed of quantum gates by driving magnetic dipole transitions.

### Prophetic Example 5

In this prophetic example, the experimental design for the characterization of opsins using triplet state microscopy are discussed.

Opsins are a family of proteins that are light-sensitive, and they play a crucial role in vision and other biological processes. Some opsins, like rhodopsin, are naturally fluorescent, while others can be engineered to become fluorescent or used with fluorescent tags. Optogenetics is the combination of genetic and optical methods used to control specific events in targeted cells of living tissue, even within freely moving mammals and other animals, with the temporal precision, i.e., millisecond timescale, needed to keep pace with functioning intact biological systems. The hallmark of optogenetics is the introduction of fast light-activated channel proteins to the plasma membranes of target neuronal cells that allow temporally precise manipulation of neuronal membrane potential while maintaining cell-type resolution through the use of specific targeting mechanisms. Among the microbial opsins which can be used to investigate the function of neural systems are the channelrhodopsins, e.g., ChR2, ChR1, VChR1, and SFOs, used to promote depolarization in response to light. The field of optogenetics has furthered the fundamental scientific understanding of how specific cell types contribute to the function of biological tissues such as neural circuits in vivo. Optogenetics-driven research has led to insights into Parkinson's disease and other neurological and psychiatric disorders. In addition to furthering the understanding of human neurological disorders, optogenetics-driven research, e.g., optogenetic stimulation of model organisms such as mice or macaques for neuroscience research, may provide valuable insights into previously unstudied parts of neurological functions.

Here, an experiment is proposed that utilizes a microscope systems akin to the embodiments illustrated in FIGS. 1, 3, and 4 to irradiate cells that express opsins. The cells and any expressed opsins will be illuminated by multiple wavelengths in standalone experiments and in two-color experiments with visible and IR photons. The illumination of the cells that express options will be coupled to patch-clamp measurements. Patch-clamp measurements are widely used to provide an electrical recording of the total or a portion of the plasma membrane containing ion channel in cells. With respect to opsins and other proteins, patch-clamp measurements will be used to measure conformational changes by way of ion channel current as the cells are irradiated with one or more colors of light to trigger fluorescence. Parallel measurements that monitor the voltage at the cell membranes, rather than the current as with the patch-clamp measurements, will be performed to assess the mechanism of fluorescence of the opsins in the Chinese hamster ovary cells.

As disclosed herein, fluorescence occurs from single photon excitation events and multiphoton excitation events. Within the spectrum of multiphoton excitation events, there are two paths to fluorescence: singlet states and triplet states. The mechanism disclosed herein provides for direct access of the normally forbidden first triplet state followed by excitation to higher order triplet states Tₙ, n>1 before reverse intersystem crossing (RISC) to the singlet excited state. Confirmation of triplet state fluorescence emissions will be assessed by an assessment of the fluorescence intensity and power. One indicator that observed fluorescence is derived from direct triplet state access is from observation of nonlinear fluorescence outside of the typical two-photon fluorescence excitation spectrum or higher than the two-photon fluorescence excitation spectrum at the excitation wavelength. Another indicator that observed fluorescence is derived from direct triplet state access is from measurements of the light source power used for excitation are substantially lower than a model of what typical two-photon fluorescence would predict the power to be.

The presence of triplet state fluorescence in opsins will also be confirmed by the characterization of output measurements from the sample. For example, fluorescence that emits green photons, e.g., about 495 to 570 nm, upon excitation with red photons or IR photons will provide evidence of triplet states. In addition, phosphorescence measurements, which are also a function of the decay of triplet states, provide further evidence of direct triplet state access. Lifetime measurements that show a reduction in phosphorescence, indicating a shorter triplet state lifetime, confirms more efficient spin-orbit coupling and enhanced rates of intersystem crossing. The slope of a power dependency curve, which is function of the output fluorescence signal and excitation intensity, provides the molar extinction coefficient E. A molar extinction coefficient of less than two indicates excitation through real intermediate triplet states. Additional experiments using oxygen scavenging species to reduce the reactivity of the background environment should confirm the involvement of the suspected dark states in the photophysical process described in this prophetic example.

### Prophetic Example 6

In this prophetic example, the experimental design for nanoscale fabrication in suitable scaffolds by multiphoton excitation using system disclosed herein is discussed.

The ability to assemble custom three-dimensional patterns of functional materials over millimeter scales with nanometer resolution would have wide-ranging impact in areas such as photonics and materials science. One approach to this problem would be to assemble the material at a more accessible length scale before shrinking it to the desired size. All shrinking methods to date have either been anisotropic or have relied on compositional changes in the substrate under extreme conditions, which limits the range of functional materials that can be used. The coil-globule transition in polymers, where hydrogels undergo volumetric phase transitions in response to mild environmental changes that alter the balance of interactions between polymer chains and the solvent, provides a path for controlled shrinkage triggered by multiphoton excitation using microscopy systems disclosed herein.

It is envisioned that polyelectrolyte gels, e.g., gelatin, chitosan, heparin, hyaluronic acid, pectin, and alginate, among others, can be patterned using fluorophores that can fluoresce by direct access of the first triplet state T₁ and higher order triplet states Tₙ, n>1, e.g., as disclosed herein. The fluorophores will be used as a patterning solution to deposit a three-dimensional pattern into the polyelectrolyte gel. Once the patterning solution is applied to the polyelectrolyte gel in the desired pattern, the polyelectrolyte gel will be irradiated with wavelengths that trigger fluorescence as disclosed herein. Fluorescence will covalently bind the fluorophores to the polyelectrolyte gel. Following covalent binding, the fluorophores will be functionalized with one or more different types of reactive groups. These reactive groups will be chosen to suit a particular end need, e.g., small molecules, biomolecules, semiconductor nanoparticles, and metal nanoparticles. Following functionalization, the polyelectrolyte gel will be shrunk to the final dimensions using chemical addition, e.g., addition of an acid or ionic solution, and dehydration. Prior to a shrinking process, the functionalized fluorophores can be further chemically modified to optimize the resultant properties of the functional group for particular end uses.

### Example 1

In this example, two-photon fluorescence of a dye using both visible and IR wavelengths is described.

Here, the chosen dye was Erythrosin B (ErB) embedded in a rigid poly(vinylalcohol) (PVA) gel as the first test bed as the dye include iodine atoms close to the xanthene rings. The iodine atoms couple to the electrons via spin-orbit interactions and were expected to increase the rate at which molecules can be populated to spin forbidden states, i.e., triplet states. It is known that the phosphorescence lifetime in ErB is on the order of microseconds which confirmed that the triplet was expected to couple well to the ground state and emit a photon.

The emission spectrum of ErB embedded in a 10% PVA gel is illustrated in FIG. 4. The main emission peak between 550-600 nm arose from fluorescence from the first excited state S₁ to the ground state S₀ and had displayed the expected lifetime in the order of nanoseconds. The small “bump” between 650-725 nm was caused by decay from the triplet state T₁ to the ground state S₀, and lead to long lived, i.e., microsecond timescale, phosphorescence. The intensity of this emission was an approximate measure of the triplet state population upon excitation.

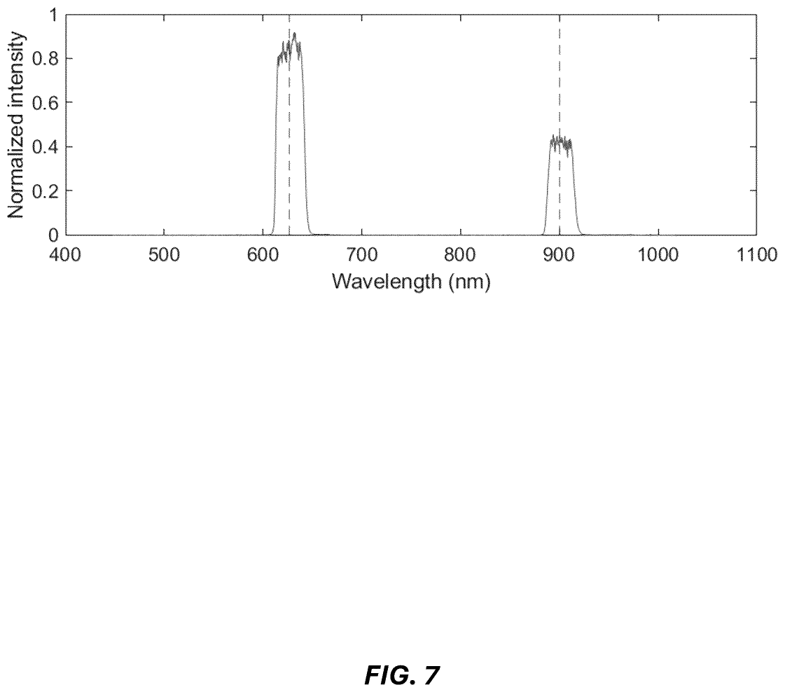

To explore two photon fluorescence in ErB, a supercontinuum laser was tuned to three different wavelengths: visible light to 470 nm (blue light), 630 nm (red light), and 900 nm (IR light). FIG. 7 illustrates the normalized intensity of the 630 nm and 900 mm light from the supercontinuum laser. Using these wavelengths, a 10 μM sample of ErB in PVA gel was excited. To prepare the ErB in PVA gel, a 10% w/w solution of PVA powder in water was prepared. The PVA solution was continuously stirred at 80° C. until substantially all the PVA powder was dissolved. The resulting solution was viscous and transparent, indicative of proper polymerization. ErB dissolved in water was added to the PVA gel. Aliquots of 10 μM ErB were dispensed, a volume of which was spread onto a coverslip (size #0, approx. 100 μm thickness) and left to dry for 2 hours. This sample was used for imaging in the downright configuration of the microscope.

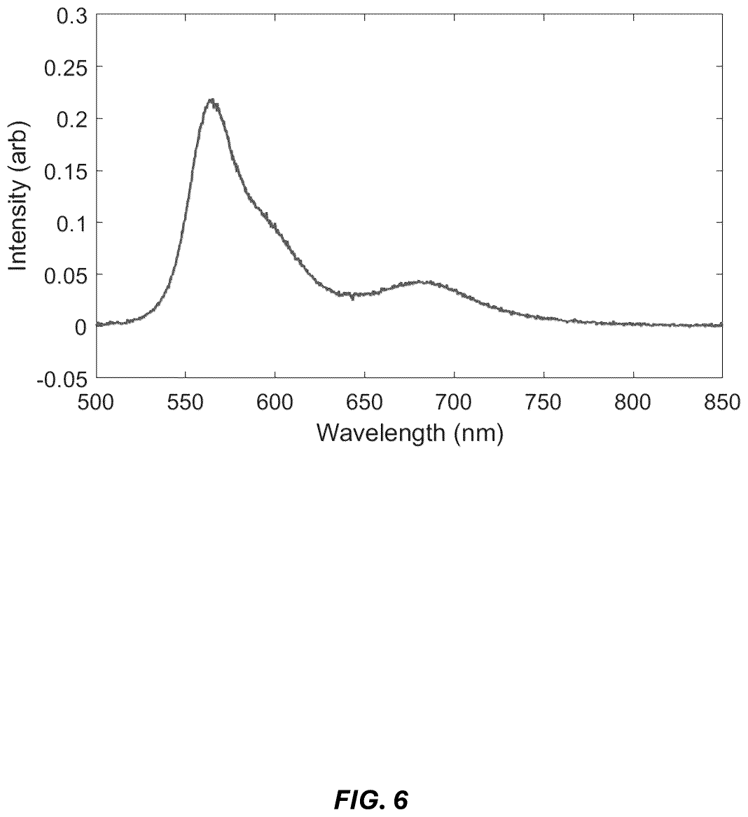

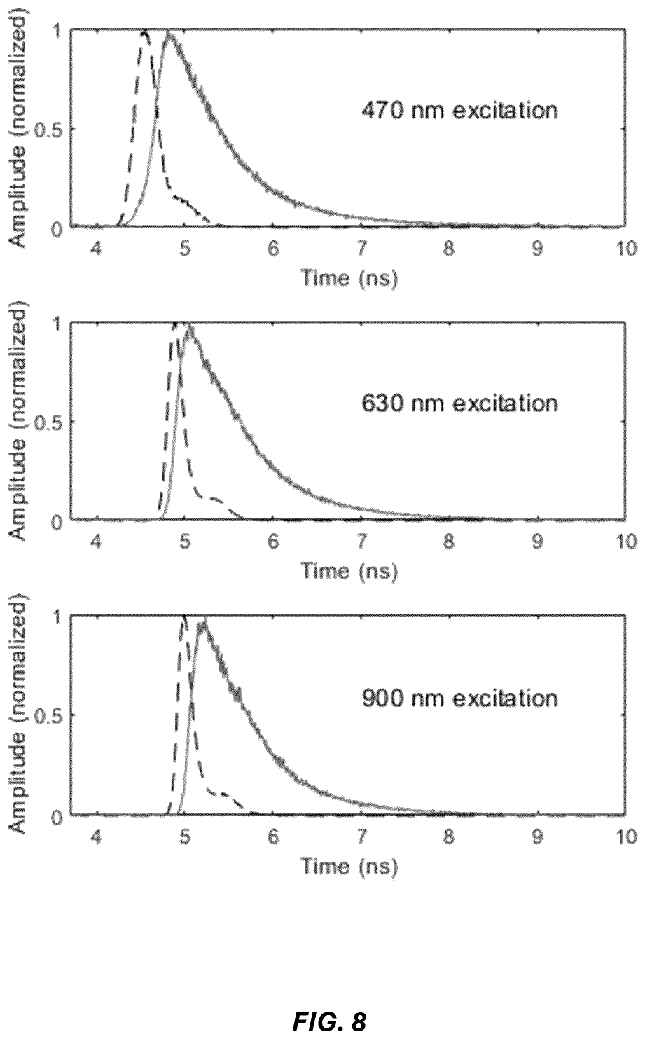

As illustrated in FIG. 6, fluorescence in the ErB in PVA gel was observed at all three wavelengths. As further illustrated in FIG. 8, the fluorescence lifetimes for 470 nm excitation, 630 nm excitation, and 900 nm excitation were broadly consistent. The three light pulses were not overlapped in time since it was determined that the source and beam paths added a temporal delay. The instrument was arranged to permit excitation with the 470 nm light first. As illustrated in FIG. 8, there were minor variations in the first part of the decay of the lifetime curve with 630 nm excitation, which suggested involvement of multiple decay channels from different states.

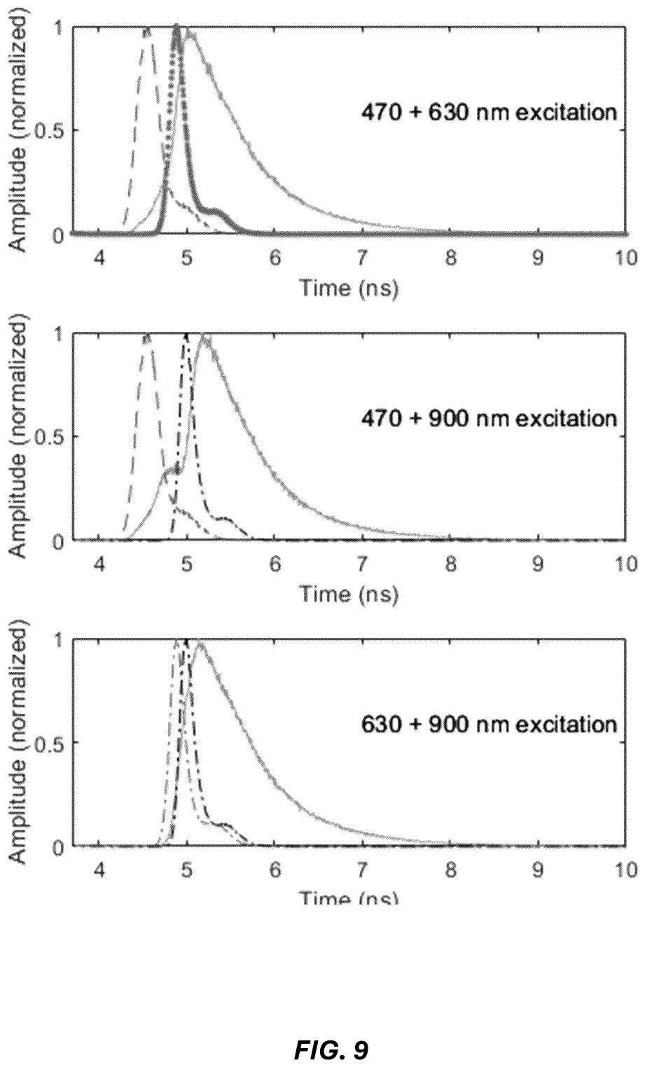

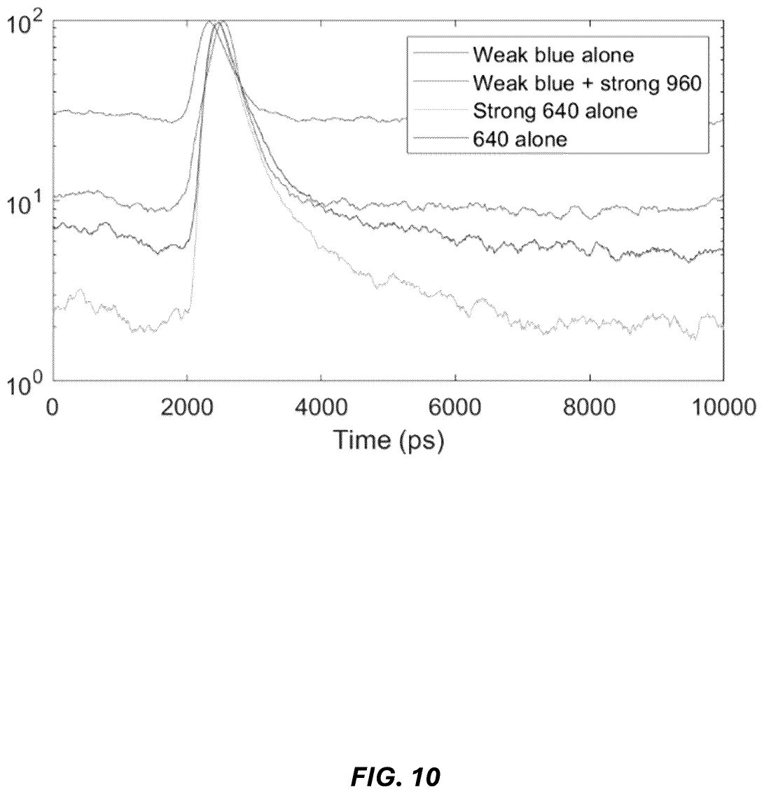

Co-illumination of the ErB sample was performed using the possible permutations of the 470 nm excitation, 630 nm excitation, and 900 nm excitation, i.e., co-illumination with 470 nm+630 nm, 470 nm+900 nm, and 630 nm+900 nm. The results of these co-illumination experiments are illustrated in FIG. 7. When the samples were co-illuminated, variations in the lifetime lineshapes were observed as seen in FIG. 9. It is noted that co-illumination of the ErB sample with 630 nm and 900 nm led to typical fluorescence, i.e., consistent with expected results of illumination with visible light. In addition to two-photon VIS-IR fluorescence, phosphorescence in the ErB sample was measured by shifting the observation wavelengths from 530 nm/55 μsed for fluorescence to 679 nm/41. This shift in corresponds to the “bump” illustrated in FIG. 6, with the phosphorescence emissions illustrated in FIG. 10. As illustrated in FIG. 10, variations in phosphorescence emission were observed. Specifically, the lifetimes in this observation interval displayed an offset that was connected to phosphorescence. As further illustrated in FIG. 10, the strength of the red 640 nm light correlated with the background level, i.e., the stronger the 640 nm light, the lower the background. This result suggested that 640 nm light could depopulate the putative triplet state before it decayed back to the ground state. FIG. 10 further illustrates that co-illumination with 470 nm+960 nm also demonstrated the same ability to depopulate the putative triplet state before it decayed back to the ground state.

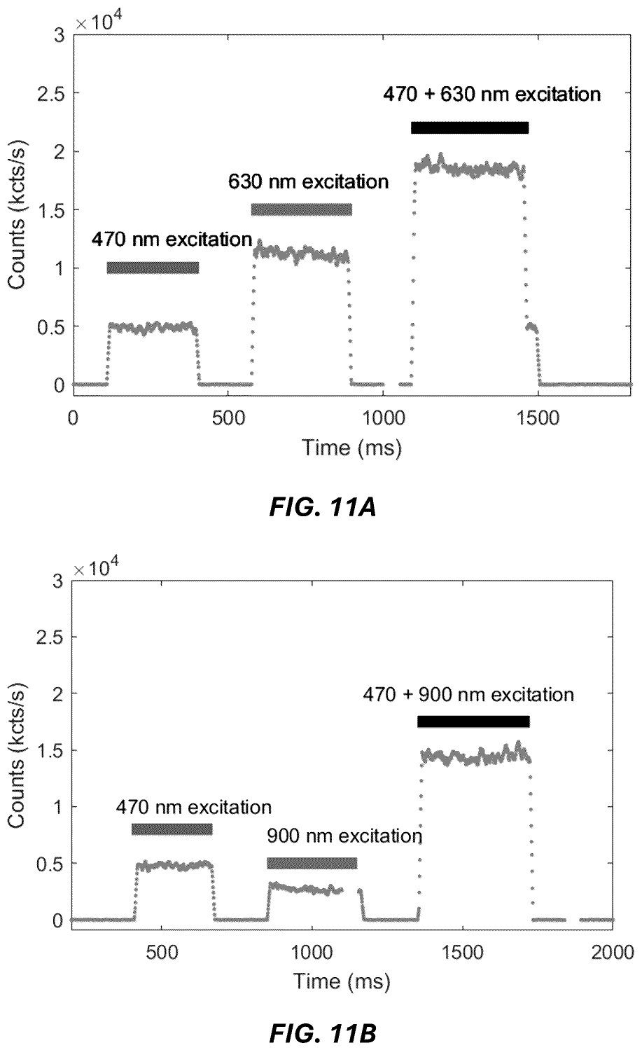

FIGS. 11A and 11B illustrate the fluorescence counts for single illumination and co-illumination for 470 nm with each of 630 nm (FIG. 11A) and 900 nm (FIG. 11B). As illustrated in FIG. 11A, the florescence counts that resulted from 470 nm+630 nm co-illumination was approximately the linear sum of the florescence counts from the individual 470 nm and 630 nm excitation, consistent with the expected mechanism for visible light fluorescence. In contrast, as illustrated in FIG. 11B, the florescence counts that resulted from 470 nm+900 nm co-illumination was greater than the linear sum of the florescence counts from the individual 470 nm and 900 nm excitation.

### Example 2

In this example, two photon fluorescence in living cells is explored using the excitation scheme disclosed herein.

Fluorescent proteins have been extensively used in the imaging of cells in the life sciences. Recombinant plasmids have been constructed that contain a fusion protein consisting of the yellow-green variant of the Aequorea victoria green fluorescent protein (GFP) coupled to multiple copies of nuclear localization signal peptides; this is known as enhanced yellow fluorescent protein (EYFP) and served as the fluorophore for this example.

EYFP was expressed in human embryonic kidney (HEK) cells by transfection with fluorescent protein plasmid using the TRANSIT-PRO® Transfection Kit from Mirus Bio (Madison, WI, USA) and its established transfection protocol. 24 hours following transfection to ensure proper expression of EFYP, the HEK cells were removed from the transfection vessel using 1 mL of trypsin. Once removed from the transfection vessel, the HEK cells were diluted with 1 mL of Dulbecco's Modified Eagle Medium (DMEM) and centrifuged. The supernatant was removed and the pellet resuspended in approximately 3-5 mL of DMEM. For excitation studies, 150 μL of the transfected HEK cells in the DMEM were pipetted into a 10 mm well in a Poly-D-Lysine coated glass bottom dish (0.085-0.115 mm thickness).

The fluorescence in the EYFP transfected HEK cells is illustrated in FIG. 12. As seen in FIG. 10, excitation with 645±15 nm and 885±25 nm was able to excite fluorescence on EYFP individually. It is noted that the 885 nm wavelength was not a compatible two-photon excitation wavelength as the two-photon process in EYFP peaks at 973 nm as shown in FIG. 10. This provided additional evidence that the two photon fluorescence disclosed herein has a different mechanism than traditional two photon fluorescence.

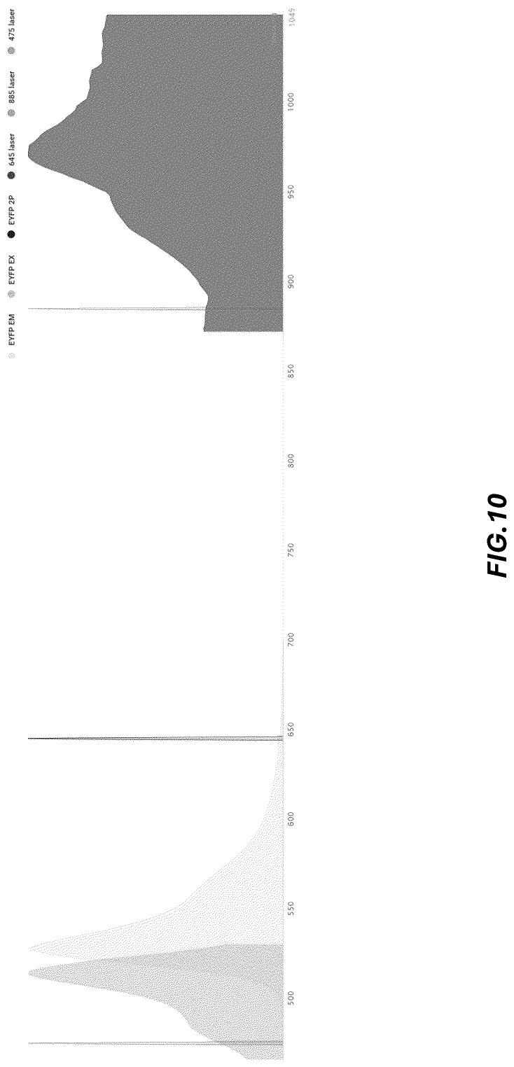

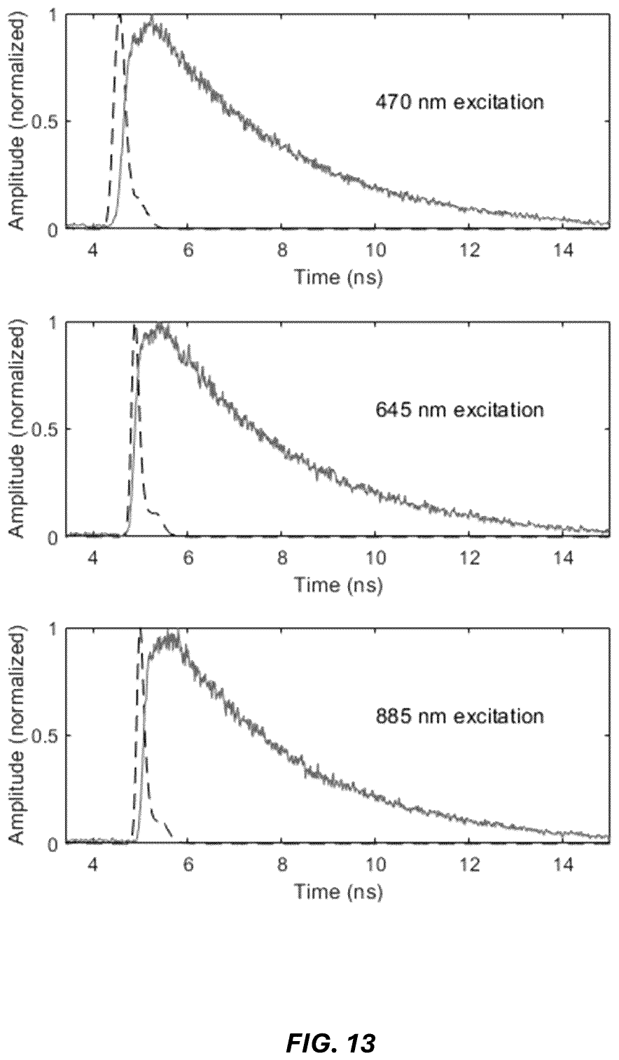

The fluorescence lifetimes for the 470 nm, 645 nm, and 885 nm excitations used to image the EYFP transfected HEK cells are illustrated in FIG. 13. As seen in FIG. 13, the fluorescence lifetimes are between each excitation wavelength are broadly similar. The timing differences between the lifetimes at each excitation wavelength are caused by the relative delays between laser pulses as described in Example 1. The fluorescence properties at each excitation wavelength were consistent and displayed statistically similar lifetimes.

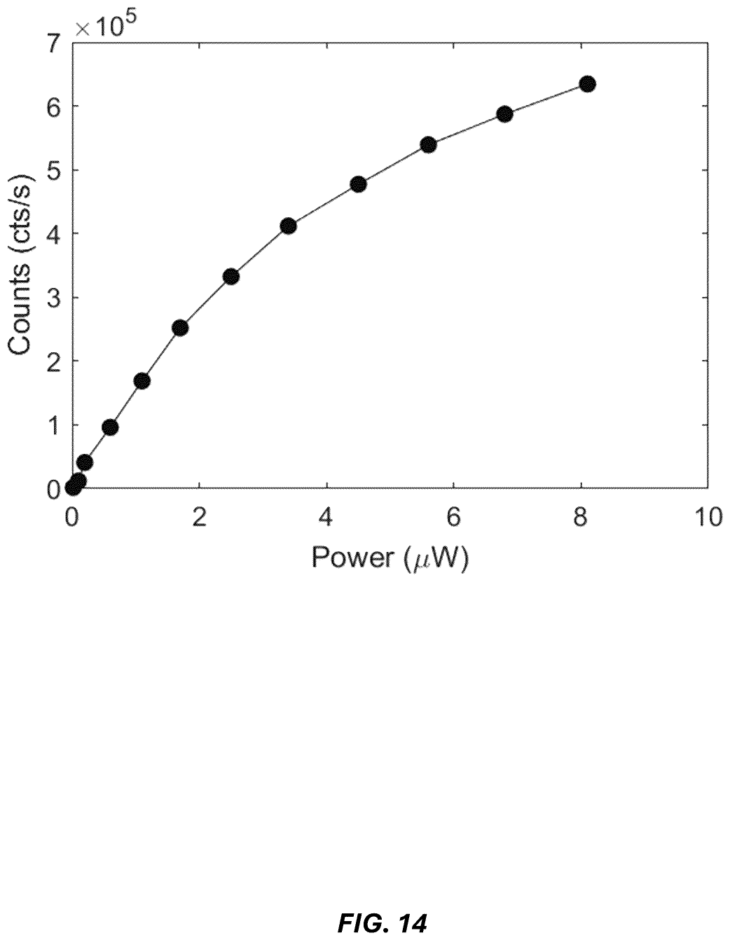

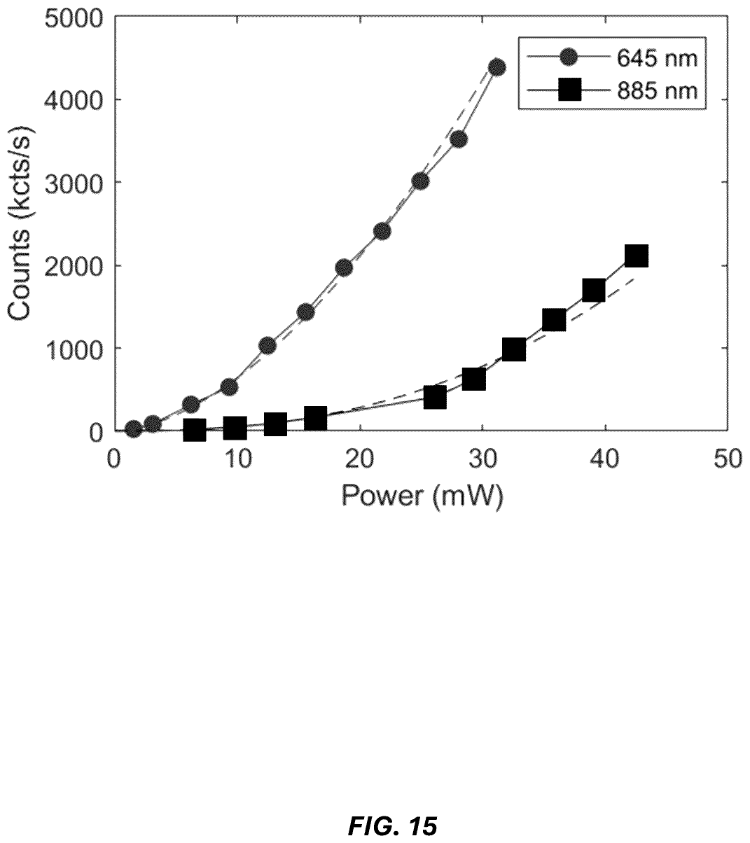

To explore the effects of laser power on fluorescence in the EYFP transfected HEK cells, power scans were performed at 470 nm, 645 nm, and 885 nm excitations. The power scan for 470 nm excitation is illustrated in FIG. 14 and showed saturation at higher laser power. In addition, the counts showed a linear dependence on laser power at power levels exceeding 2 μW. In order to confirm that the excitations at 645 nm and 885 nm excitations were indeed exhibiting nonlinear effects, power scans were performed separately at each wavelength. The resulting power scans are illustrated in FIG. 15. As illustrated in FIG. 15, the power scans at each wavelength were nonlinear. Fitting the power scans to exponential functions resulted in nonlinear exponents of 1.75 for the 645 nm excitation and 2.45 for the 885 nm excitation. There was a clear observation of nonlinearity for each excitation wavelength with no evidence of a significant fluorescence enhancement using co-illumination.

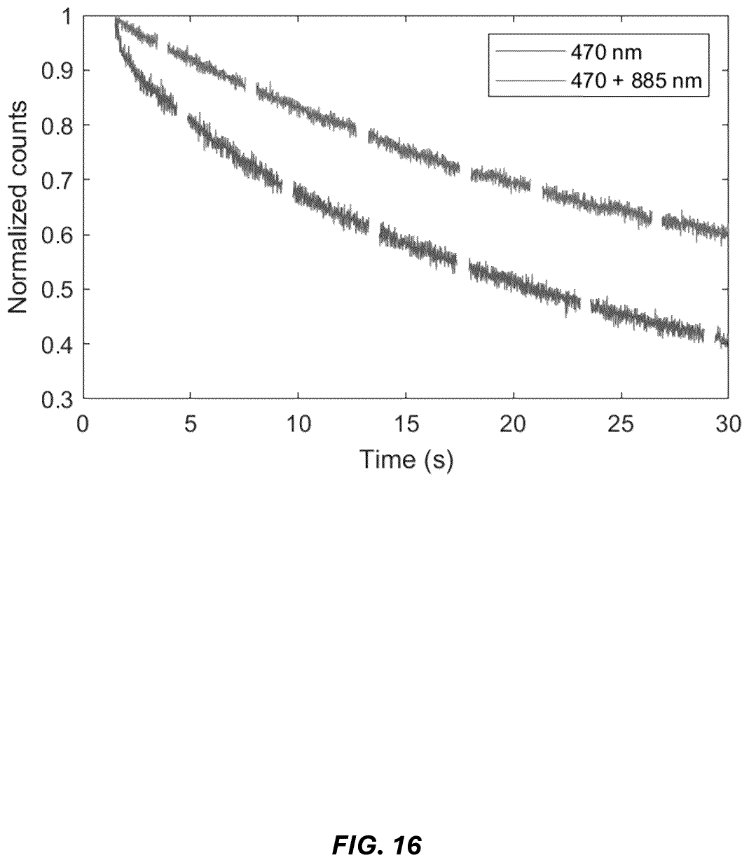

An additional observation was that photobleaching rate was slower using co-illumination with 470 nm and 885 nm. This is illustrated in FIG. 16, with the orange trace illustrating the photobleaching using co-illumination with 470 nm and 885 nm. The variability of the power scan exponent and slower photobleaching indicated that the background environment of the excitation was a contributing factor and that the 885 nm excitation was depumping transitions from a dark or bleaching state. Additional experiments using oxygen scavenging species to reduce the reactivity of the background environment should confirm the involvement of the suspected dark states in the photophysical process described in this Example.

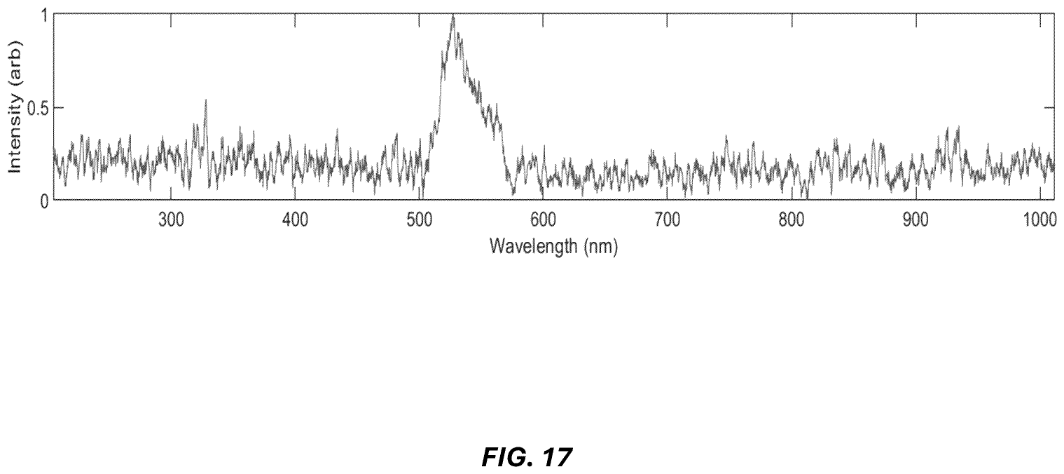

In addition to the pulsed lasers used in the experiments of Example 1 and this example, fluorescence in the EYFP transfected HEK cells was observed using a continuous wave (CW) diode laser with an excitation wavelength of 638 nm. The output mode of the diode laser was not optimized, which decreased the efficiency of photon interactions due to poor beam focusing. FIG. 17 illustrates the emission spectrum when exciting the EYFP transfected HEK cells with CW red light with the laser power estimated to be in tens of mW.

### Example 3

In this example, two-photon fluorescence of a dye using both visible and IR wavelengths is described.

A system akin to that illustrated in FIG. 1 was used for this study. A supercontinuum laser (SC, FIU-15, NKT) provided picosecond pulses at variable repetition rate and wavelength. A dichroic filter (D1, cDi02-R594-25x36, AVR) split the beam into visible (400-600 nm) and red/IR beam paths. The visible path incorporated an AOTF (48062-1-0.55-1W, Neos) for amplitude control and spectral filtering (F1, FGS900-A, Thorlabs). The red/IR path used three filters to eliminate spurious visible light (long-pass F2: FGL630M, short-pass F3: FESH1000, Thorlabs; tunable filter pair TFP: LF104550/LF104555, Delta), with amplitude control via a liquid crystal modulator (Mod 1, LCC1622, Thorlabs) and 6× expansion (Ex1, BE06R, Thorlabs).

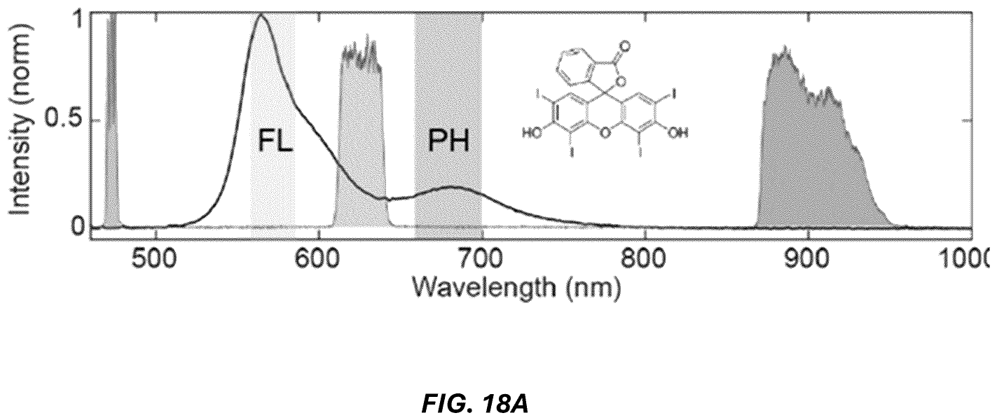

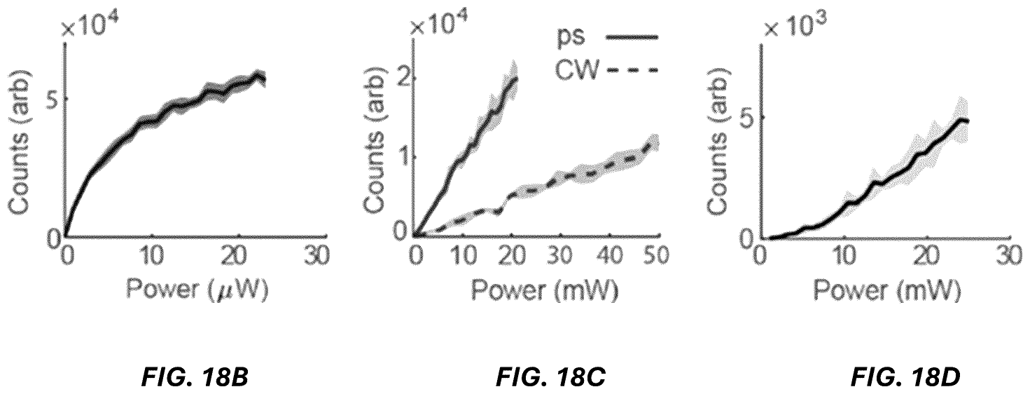

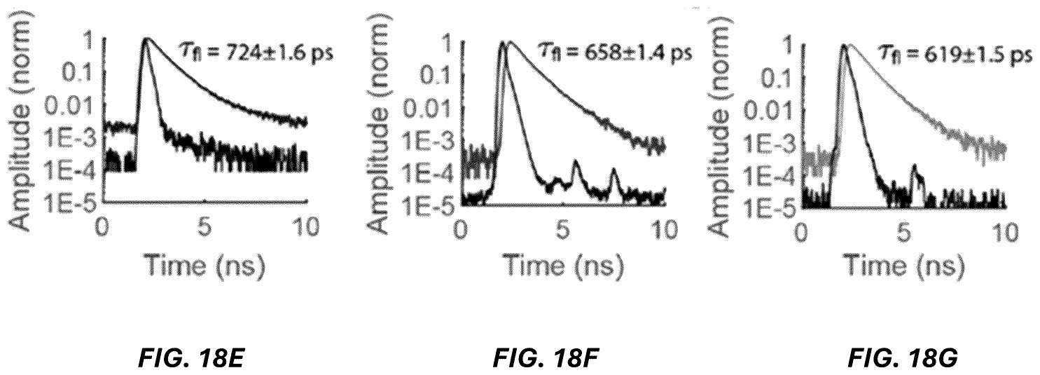

The visible and red/IR beams were combined by dichroic filters (D2: FF495-Di, AVR; D3: 610lpxr-t3-Di, Chroma) and directed to the objective (UPLXAPO 40×, 0.95 NA, Olympus). Fluorescence was detected through an emission filter (F4, ET535/70m, AVR) and phosphorescence was detected using a dichroic filter (D4, FF660-Di-lpxr, Chroma) with a bandpass filter (F5, FF01-679/41-25, AVR). Both signals were focused by tube lenses to a photon counter (FastGatedSPAD, MPD) and digitized (Time Tagger Ultra, Swabian) for lifetime measurements. Excitation was characterized at the sample plane using power scans as illustrated in FIGS. 18B-18D. As seen in FIGS. FIGS. 18B-18D, power ranges were 0-30 μW (blue), 0-20 mW (red), and 0-30 mW (infrared) measured at the sample plane.

The dye sample was embedded in 10% (w/w) polyvinyl alcohol (PVA) in water at 10 μM concentration. A thin film was deposited on a #0 coverslip and dried for 2 hours. This low concentration was chosen to avoid aggregation effects, enabling characterization of the monomeric species.

The emission spectra in FIG. 18A show the detection band FL and phosphorescence band PH which isolate the main fluorescence peak at 565 nm and secondary peak at 680 nm, associated with phosphorescence emission, respectively. A power dependent signal in the fluorescence detection band (FL) was detected with single-wavelength excitation at 626±20 nm and 900±30 nm (FIGS. 18B-18D) with lifetime decays similar to conventional single photon excitation at 472±8 nm of 724±1.6 ps which confirmed emission from a fluorescent state S₁ as shown in FIGS. 18E-18G. Saturation effects were not observed at red/infrared wavelengths. Moreover, red CW laser light at 660 nm (LP660-SF50, Thorlabs) also produced fluorescence (shown in FIG. 18B) at four times higher power than the picosecond pulsed light, further confirming the ability of systems disclosed in FIGS. 1, 3, and 4 to produce fluorescence emission at lower power. The proximity of the red light to the phosphorescence peak suggested direct stimulation of the triplet state.

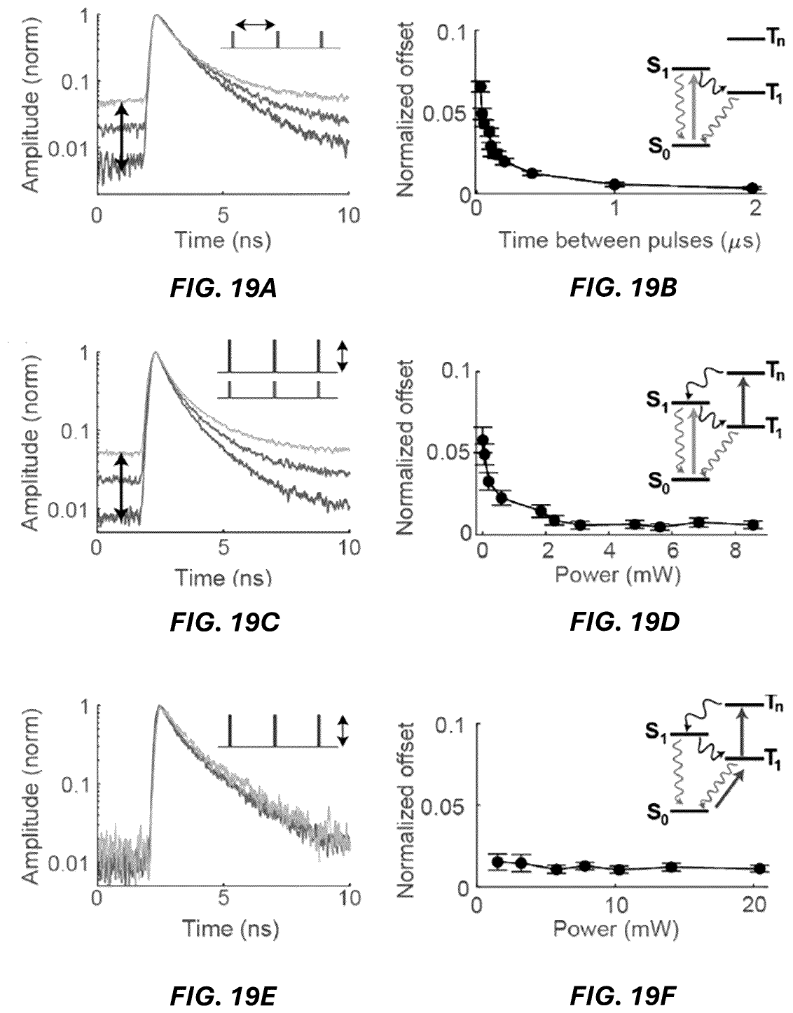

To rule out excitation of different species and further characterize the triplet state, the triplet state lifetime was estimated as shown in FIG. 19A. When switching the detection band to the phosphorescence channel (PH) and exciting the sample with blue pulses, a constant offset produced by phosphorescence of decayed population from the T₁ state was observed as result of intersystem crossing from the S₁. An increase in the pulse-to-pulse time revealed a decrease in this offset, shown in FIG. 19B, which permitted estimation of a slow decay constant of 2.25±0.1 ns. The relatively short triplet lifetime, while longer than the fluorescence lifetime (724±1.6 ps), was consistent with efficient spin-orbit coupling due to the presence of iodine atoms in ErB, which is known to enhance intersystem crossing rates.

Using a train of temporally overlapped blue and red pulses at 40 MHz repetition rate, the triplet state manifold was interrogated. Increasing red light power led to a monotonic decrease in the offset as observed in FIG. 19C-19D with a depletion saturation power of 0.4±0.1 mW. This indicated that red excitation promoted population from T₁ to a higher triplet state Tₙ, followed by reverse intersystem crossing to the fluorescent state S₁.

It was postulated that a population transfer from the ground state S₀ to the T₁ would require higher optical power due to its forbidden nature. In this power regime, no population would be trapped in the T₁ state due to optical pumping to Tₙ at the same wavelength, producing no offset. Moreover, this multiphoton process would be rate limited by the S₀→T₁ transition, showing a linear power dependence before saturation. The results, illustrated in FIGS. 19E-19F, show good agreement with this postulated model, explaining the linear trend of power versus signal of FIG. 18C and providing further evidence for direct stimulation to triplet states.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A system for irradiating a sample, comprising:
one or more light sources configured to produce a light beam having a wavelength range to produce a population of excited singlet states derived from relaxation of a population of higher order triplet states in the sample;
an optical assembly constructed and arranged direct the light beam; and
a first objective constructed and arranged to irradiate the sample with the light beam.

2. The system of claim 1, wherein the one or more light sources is a visible light source.

3. The system of claim 2, wherein the visible wavelength range is between about 400 nm to about 700 nm.

4. The system of claim 1, wherein the one or more light sources is an infrared (IR) light source.

5. The system of claim 4, wherein the IR wavelength range is between about 750 nm to about 1000 nm.

6. The system of claim 1, wherein the one or more light sources comprises a pulsed light source or a continuous wave light source.

7. The system of claim 6, wherein the one or more light sources comprises a fixed wavelength light source.

8. The system of claim 6, wherein the one or more light sources comprises a supercontinuum light source.

9. The system of claim 8, wherein the wavelength range from the supercontinuum is set using a filter selected from the group consisting of an acousto-optic tunable filter and a linear variable filter.

10. The system of claim 1, further comprising a second objective constructed and arranged to collect a signal representative of fluorescence in the sample.

11. The system of claim 1, further comprising a detector constructed and arranged to receive the signal representative of fluorescence in the sample and to provide an output representative thereof.

12. A method of irradiating a sample, comprising:
generating from one or more light sources one or more light beams having a wavelength range chosen to produce a population of excited singlet states derived from relaxation of a population of higher order triplet states in the sample;
applying the one or more light beams to the sample using an objective to produce a population of triplet states and a population of excited singlet states in the sample.

13. The method of claim 12, further comprising detecting fluorescence from the sample.

14. The method of claim 12, wherein the one or more light sources is a visible light source.

15. The method of claim 14, wherein the visible wavelength range is between about 400 nm to about 700 nm.

16. The method of claim 12, wherein the one or more light sources is an infrared (IR) light source.

17. The method of claim 16, wherein the IR wavelength range is between about 750 nm to about 1000 nm.

18. The method of claim 12, wherein one or more light sources comprises a pulsed light source or a continuous wave light source.

19. The method of claim 18, wherein the one or more light sources comprises a fixed wavelength light source or a supercontinuum light source.

20. A system for irradiating a sample, comprising:
one or more light sources configured to a light beam having a wavelength range to produce a population of a first triplet state in the sample via excitation of a ground state in the sample and a population of higher order triplet states in the sample via excitation of a first triplet state in the sample and a population of excited singlet states derived from relaxation of a population of higher order triplet states in the sample;
an optical assembly constructed and arranged direct the light beam; and
a first objective constructed and arranged to irradiate the sample with the light beam.
